(19) United States
(12) Patent Application Publication
(10) Pub. No.: US 2025/0271858 A1
(43) Pub. Date: Aug. 28, 2025

(54) System and Method for Determining the Pose of an Aerial Vehicle Using Absolute Visual Localization of Route Features

(71) Applicant: Nurenda Technologies, Dublin (IE)

(72) Inventor: Paolo MOLONEY, Dublin (IE)

(21) Appl. No.: 19/057,886

(22) Filed: Feb. 19, 2025

Related U.S. Application Data
(60) Provisional application No. 63/556,690, filed on Feb. 22, 2024.

(51) Int. Cl. G05D 1/246; G06V 10/75; G06V 10/82; G06V 20/17

(52) U.S. Cl. CPC G05D 1/2462; G06V 10/758; G06V 10/82; G06V 20/17

(57) ABSTRACT

The system and methods of the various embodiments may enable an aerial vehicle to determine its pose using absolute visual localization of route features and either a keypoint-based pipeline or a template based pipeline. This may result in the aerial vehicle being able to determine its pose when traditional methods of pose detection fail.

### RELATED APPLICATIONS

This application claims the benefit of priority to U.S. Provisional Application No. 63/556,690, entitled “System and Method for Determining the Pose of an Aerial Vehicle Using Absolute Visual Localization of Route Features” filed Feb. 22, 2024, the entire contents of which are hereby incorporated by reference herein for all purposes.

### BACKGROUND

Aerial vehicles (e.g., drones, unmanned aerial vehicles (UAV)) rely on various navigation techniques to determine position and orientation during flight. Accurate navigation is necessary for maintaining stability, executing flight plans, and avoiding obstacles in dynamic environments. Traditional navigation systems often integrate multiple sensor modalities, such as inertial measurement units (IMUs), satellite-based positioning systems, and image-based localization techniques.

IMUs measure acceleration and angular velocity to estimate changes in position and orientation over time. These measurements may be susceptible to drift, requiring periodic correction using external references. Satellite-based positioning systems, such as the Global Navigation Satellite System (GNSS), provide absolute position data but may experience reduced accuracy in environments with signal obstructions, such as urban canyons or dense foliage.

### SUMMARY

The various aspects include methods of determining the pose of an aerial vehicle using route features, the method including receiving, at a processing system of the aerial vehicle, mission parameters from a pre-flight planning system, the mission parameters including a route, route features, and a coordinate mapping function, in which the route features include at least one tile feature, capturing, using an on-board image sensor of the aerial vehicle, a query image of an area corresponding to the route, computing, by the processing system, query image features from the query image, determining, by the processing system, candidate tile features from the route features based on the mission parameters, matching, by the processing system, the query image features to the candidate tile features to identify a matching tile, determining, by the processing system, pixel coordinates of the aerial vehicle within the matching tile, determining, by the processing system, a pose of the aerial vehicle using the pixel coordinates and the coordinate mapping function, and sending the determined pose to a flight control computer of the aerial vehicle.

In some aspects, receiving the mission parameters may include receiving a threshold score associated with pixel coordinate accuracy, and determining the pixel coordinates of the aerial vehicle may include calculating a confidence score for the pixel coordinates, and discarding the pixel coordinates in response to determining that the confidence score is below the threshold score. In some aspects, capturing the query image may include adjusting the exposure of the query image based on ambient lighting conditions. In some aspects, capturing the query image may include adjusting the query image based on orientation data obtained from an inertial measurement unit (IMU) of the aerial vehicle.

In some aspects, computing the query image features may include detecting at least one keypoint in the query image, and generating a descriptor for each detected keypoint, In some aspects, matching the query image features to the candidate tile features may include selecting at least one candidate tile keypoint corresponding to a detected query image keypoint, determining a candidate tile score by computing a distance metric between a descriptor of the query image keypoint and a descriptor of the candidate tile keypoint, and selecting a best candidate tile based on the candidate tile score, and in which determining the pixel coordinates of the aerial vehicle may include generating a homography matrix based on the best candidate tile, and applying the homography matrix to the pixel coordinates of a central region of the query image.

In some aspects, generating the descriptor for each detected keypoint may include generating a feature vector representing spatial relationships of pixel coordinates relative to the keypoint. In some aspects, computing the query image features may include generating a tensor representation of the query image by performing inference on the query image using a convolutional neural network (CNN), matching the query image features to the candidate tile features may include convolving the tensor representation with at least one candidate tile feature tensor, and determining the pixel coordinates of the aerial vehicle may include selecting pixel coordinates associated with a highest confidence score from the convolved tensor. In some aspects, determining the candidate tile features may include selecting candidate tile features based on a previously determined pose of the aerial vehicle.

Some aspects may further include receiving, at the flight control computer, the determined pose, generating, using the flight control computer, a unified pose estimate by combining the determined pose with additional sensor-based poses, evaluating, using the flight control computer, the unified pose against the route parameters, determining, using the flight control computer, a route adjustment based on a deviation from the route parameters, and adjusting, using the flight control computer, at least one flight control parameter, in which the flight control parameter may include at least one of thrust or control surface position.

Some aspects may further include receiving, at the pre-flight planning system, georeferenced map images, segmenting, using the pre-flight planning system, the georeferenced map images into tiles, and generating, using the pre-flight planning system, tile features for each tile. In some aspects, segmenting the georeferenced map images into tiles may include segmenting the images based on at least one of a processing capability of the aerial vehicle, a storage constraint of the aerial vehicle, or a route length parameter.

In some aspects, generating the tile features may include detecting, using the pre-flight planning system, at least one keypoint in each tile, generating, using the pre-flight planning system, a descriptor for each detected keypoint, associating, using the pre-flight planning system, the keypoint and descriptor with tile metadata, and storing the tile metadata as part of the tile features.

In some aspects, generating the tile features may include generating, using the pre-flight planning system, a tensor representation for each tile by performing inference on the tile using a convolutional neural network (CNN), and associating, using the pre-flight planning system, the tensor representation with the corresponding tile features.

Some aspects may further include receiving, at the pre-flight planning system, mission requirements including an origin and a destination, calculating, using the pre-flight planning system, a route based on the mission requirements, retrieving, using the pre-flight planning system, tile features associated with the route, storing, using the pre-flight planning system, the retrieved tile features as part of the route features, and deploying, from the pre-flight planning system, mission parameters to the aerial vehicle, in which the mission parameters include the route, the route features, and the coordinate mapping function.

Further aspects may include a computing device having a processor or processing system configured with processor-executable instructions to perform various operations corresponding to the methods discussed above. Further aspects may include a computing device having various means for performing functions corresponding to the method operations discussed above. Further aspects may include a non-transitory processor-readable storage medium having stored thereon processor-executable instructions configured to cause a processor or processing system to perform various operations corresponding to the method operations discussed above.

Further aspects may include an aerial vehicle having a processor or processing system configured with processor-executable instructions to perform various operations corresponding to the methods discussed above. Further aspects may include a flight control computer having a processor or processing system configured with processor-executable instructions to perform various operations corresponding to the methods discussed above. Further aspects may include a pre-flight planning system having a processor or processing system configured with processor-executable instructions to perform various operations corresponding to the methods discussed above.

### BRIEF DESCRIPTION OF THE DRAWINGS

The accompanying drawings, which are incorporated herein and constitute part of this specification, illustrate exemplary aspects of the invention, and together with the general description given above and the detailed description given below, serve to explain the features of the invention.

FIG. 1 is a block diagram illustrating various components used with an example embodiment.

FIG. 2 is a block diagram illustrating an aerial vehicle suitable for using with various embodiments.

FIG. 3A is a block diagram illustrating the internal components of a NASR compute and sensor module suitable for using with various embodiments.

FIG. 3B is a block diagram illustrating an example embodiment of a NASR compute and sensor module.

FIG. 4 is a process flow diagram illustrating a method of controlling the flight of an aerial vehicle in accordance with some embodiments.

FIGS. 5A-5D are process flow diagrams illustrating a method of preparing an aerial vehicle for a mission in accordance with some embodiments.

FIGS. 6A-6D are examples of map images and routes for use in accordance with some embodiments.

FIG. 7 is an example of a map images that have been chunked to create tiles in accordance with some embodiments.

FIGS. 8A-8C are process flow diagrams illustrating a method of generating a pose using a NASR compute and sensor module in an aerial vehicle in accordance with some embodiments.

FIG. 9 is a process flow diagram illustrating a method of generating a pose using a keypoint-based pipeline in a NASR compute and sensor module in an aerial vehicle in accordance with some embodiments.

FIG. 10 is a process flow diagram illustrating a method of generating a pose using a template-based pipeline a NASR compute and sensor module in an aerial vehicle in accordance with some embodiments.

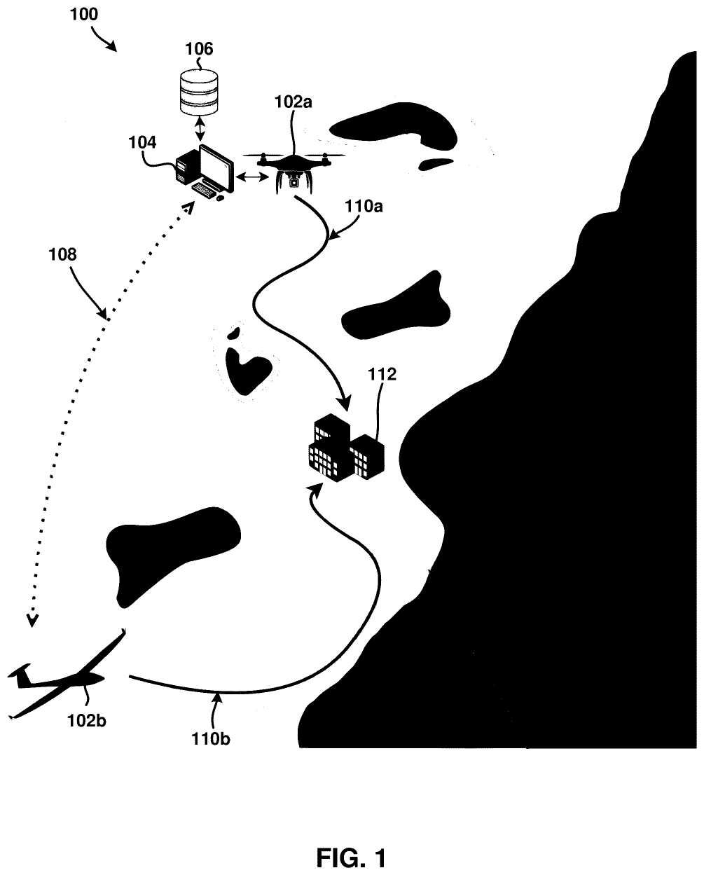

FIG. 1 is a system block diagram of a computing system that may be included in an aircraft and/or in a ground control station (GCS) and configured to implement some embodiments.

FIG. 12 is a component diagram of a server suitable for implementing some embodiments.

### DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration”. Any implementation described herein as “exemplary” is not necessarily to be construed as preferred or advantageous over other implementations.

The terms “component,” “system,” and the like may be used herein to refer to a computer-related entity, such as hardware, firmware, a combination of hardware and software, software, or software during its execution. These entities may be configured to carry out specific operations or functionalities. For example, a component may encompass a process operating on a processor, a processor itself, an object, an executable, a thread of execution, a program, or a computing device. As an illustrative example, both an application running on a computing device and the computing device itself could be termed a component. One or more components may be situated within a process and/or thread of execution and/or may be localized on a single processor or core or distributed across multiple processors or cores. In addition, these components may execute from various non-transitory computer-readable media having various instructions and/or data structures stored thereon. Components may communicate by way of local and/or remote processes, function or procedure calls, electronic signals, data packets, memory read/writes, and other known computer, processor, and/or process-related communication methodologies.

The term “processing system” may be used herein to refer to one or more processors, including multi-core processors, that are organized and configured to perform various computing functions. Various embodiment methods may be implemented in one or more of multiple processors within a processing system as described herein. As such, a computing device tasked with enacting the functionalities described herein may include a processing system with one or multiple processors. The computing device may be a standalone entity or a component of a system-on-chip (SoC). A SoC typically integrates multiple resources, which may encompass specialized processors such as a network, digital signal, or video processor. These specialized processors might be accompanied by memory blocks and other resources for efficient operation. The SoC may include software for controlling these integrated resources, as well as for managing peripheral devices.

The term “system on chip” (SoC) may be used herein to refer to a single integrated circuit (IC) chip that includes multiple resources or independent processors integrated on a single substrate. A single SoC may include circuitry for digital, analog, mixed-signal, and radio-frequency functions. A single SoC may include a processing system that includes any number of general-purpose or specialized processors (e.g., network processors, digital signal processors, modem processors, video processors, etc.), memory blocks (e.g., ROM, RAM, Flash, etc.), and resources (e.g., timers, voltage regulators, oscillators, etc.). For example, an SoC may include an applications processor that operates as the SoC's main processor, central processing unit (CPU), microprocessor unit (MPU), arithmetic logic unit (ALU), etc. An SoC processing system also may include software for controlling integrated resources and processors, as well as for controlling peripheral devices.

The term “pose” may be used to refer to a combination of an object's orientation and position within a reference frame. The term “orientation” may refer to a set of angular measurements, including heading, yaw, roll, and pitch. The term “position” may refer to spatial coordinates within a reference system, such as latitude, longitude, and altitude. A pose may be expressed using a specified number of degrees of freedom (e.g., 6 degrees of freedom (DoF) defining three-dimensional position and three-dimensional orientation).

The term “aerial vehicle” may be used to refer to any device or machine capable of airborne travel without contacting a surface. An aerial vehicle may be a manned aircraft (e.g., a light aircraft, a commercial aircraft, etc.) or an unmanned aerial vehicle (UAV) (e.g., a drone, a satellite, etc.). An aerial vehicle may include control systems for navigation, stability, and propulsion.

The term “positioning system” may be used to refer to any system that is capable of determining its pose. A positioning system may include a Global Navigation Satellite System (GNSS) (e.g., GPS, Galileo) or an Inertial Measurement Unit (IMU), which may measure acceleration and angular velocity to estimate orientation and position.

The term “neural network” may be used herein to refer to an interconnected group of processing nodes (or neuron models) that collectively operate as a software application or process that controls a function of a computing device and/or generates an overall inference result as output. Individual nodes in a neural network may attempt to emulate biological neurons by receiving input data, performing simple operations on the input data to generate output data, and passing the output data (also called “activation”) to the next node in the network. Each node may be associated with a weight value that defines or governs the relationship between input data and output data. A neural network may learn to perform new tasks over time by adjusting these weight values. In some cases, the overall structure of the neural network and/or the operations of the processing nodes do not change as the neural network learns a task. Rather, learning is accomplished during a “training” process in which the values of the weights in each layer are determined. As an example, the training process may include causing the neural network to process a task for which an expected/desired output is known, comparing the activations generated by the neural network to the expected/desired output, and determining the values of the weights in each layer based on the comparison results. After the training process is complete, the neural network may begin “inference” to process a new task with the determined weights.

The term “inference” may be used herein to refer to a process that is performed at runtime or during execution of the software application program corresponding to the neural network. Inference may include traversing the processing nodes in the neural network along a forward path to produce one or more values as an overall activation or overall “inference result”.

The term “deep neural network” may be used herein to refer to a neural network that implements a layered architecture in which the output/activation of a first layer of nodes becomes an input to a second layer of nodes, the output/activation of a second layer of nodes becomes an input to a third layer of nodes, and so on. As such, computations in a deep neural network may be distributed over a population of processing nodes that make up a computational chain. Deep neural networks may also include activation functions and sub-functions between the layers. The first layer of nodes of a multilayered or deep neural network may be referred to as an input layer. The final layer of nodes may be referred to as an output layer. The layers in-between the input and final layer may be referred to as intermediate layers.

The term “convolutional neural network” (CNN) may be used herein to refer to a deep neural network in which the computation in at least one layer is structured as a convolution. A convolutional neural network may also include multiple convolution-based layers, which allows the neural network to employ a very deep hierarchy of layers. In convolutional neural networks, the weighted sum for each output activation is computed based on a batch of inputs, and the same matrices of weights (called “filters”) are applied to every output. These networks may also implement a fixed feedforward structure in which all the processing nodes that make up a computational chain are used to process every task, regardless of the inputs. In such feed-forward neural networks, all of the computations are performed as a sequence of operations on the outputs of a previous layer. The final set of operations generate the overall inference result of the neural network, such as a probability that an image includes a specific object (e.g., a person, cat, watch, edge, etc.) or information indicating that a proposed action should be taken.

The term “flight management system” (FMS) may be used herein to refer to an avionics system configured to automate and assist with aerial vehicle navigation. An FMS may be implemented as a computing system onboard an aerial vehicle and/or within a ground control station (GCS). An FMS may manage flight planning, waypoints, altitude adjustments, speed control, and autopilot functions. The FMS may interact with navigation sensors, communication systems, and onboard computing resources to maintain an aerial vehicle's flight path. For example, the FMS may control the aerial vehicle's speed and altitude, and perform various in-flight tasks, such as managing the flight plan and autopilot functions to autonomously guide the aerial vehicle to its destination (i.e., when it is coupled with an automatic flight control system (AFCS), etc.). In some embodiments, the FMS onboard the aerial vehicle may be configured to work in conjunction with a ground control station as part of manned, unmanned, and/or semi-autonomous operations.

The term “waypoint” may be used herein to refer to a predefined geographical location used to define an aerial vehicle's flight path. A waypoint may be specified using spatial coordinates (e.g., latitude, longitude, altitude). A flight plan may include an ordered sequence of waypoints that define a route, including departure and arrival procedures, altitude changes, and speed adjustments.

The term “beyond visual line of sight” (BVLOS) may refer to an operational mode in which an aerial vehicle navigates outside the direct visual observation range of a human operator. BVLOS operations may require autonomous navigation capabilities, remote sensing technologies (e.g., cameras, radar, lidar, GNSS, IMU, etc.), and communication links to maintain situational awareness. BVLOS may support aerial vehicle applications such as cargo transport, infrastructure inspection, environmental monitoring, and search and rescue missions.

Modern aerial vehicles (e.g., drones, UAVs, etc.) support a broad range of applications in military, civilian, and commercial fields. These vehicles may transport cargo, conduct surveillance, support agriculture, and assist in search and rescue missions. Unlike ground-based systems, aerial vehicles operate in three-dimensional space and may traverse remote or hazardous environments, expanding operational capabilities beyond conventional transportation and monitoring solutions. However, these capabilities depend on precise navigation and positioning to avoid obstacles, follow designated routes, and execute tasks accurately.

Navigation systems rely on pose information, which includes orientation and position, to determine an aerial vehicle's location relative to its surroundings. Many aerial vehicles derive pose information from global navigation satellite systems (GNSS). GNSS signals, though widely used, may become unreliable due to environmental interference, signal jamming, or obstruction from terrain and urban structures. Solar activity (e.g., coronal mass ejections, solar storms, etc.) may also disrupt GNSS signals. When an aerial vehicle operates beyond visual line of sight (BVLOS), it may require an independent source of absolute pose information to maintain redundancy and ensure operational reliability.

Visual localization provides an alternative means of determining pose information by analyzing environmental features. Instead of relying on satellite signals, visual localization uses onboard imaging systems to compare real-time visual data with reference images or mapped features. Absolute visual localization (AVL) applies this concept to large-scale navigation by recognizing distinct visual landmarks along a predetermined route. AVL may enable aerial vehicles to determine position and orientation even when GNSS signals degrade or become unavailable. This approach supports navigation in complex environments, such as urban landscapes, dense forests, and high-altitude regions, where signal obstruction frequently occurs.

Aerial vehicles equipped with AVL may incorporate complementary metal-oxide-semiconductor (CMOS)-based cameras as primary visual sensors. CMOS-based cameras may provide advantages over active sensing technologies such as light detection and ranging (LiDAR). Unlike LiDAR, which emits detectable signals, CMOS-based cameras function as passive sensors, allowing aerial vehicles to operate covertly in security-sensitive environments. These cameras may also capture long-range visual data, provide a wide field of view, and maintain a reduced size, weight, power, and cost (SWaP-C) profile, making them suitable for integration into resource-constrained aerial platforms.

Visual localization may introduce challenges related to environmental variability and feature recognition. Changes in lighting due to time of day or weather conditions may alter the appearance of mapped features, affecting consistency between real-time and reference images. Moving objects may occlude critical landmarks, while variations in perspective—such as translation, rotation, and scale shifts—may further complicate image matching. At high altitudes, homogeneous terrain, such as dense forests or desert landscapes, may lack distinctive visual features, increasing the likelihood of false data associations and reducing localization accuracy.

AVL-based pose estimation may enhance the autonomy and reliability of aerial vehicles by providing real-time position and orientation data without reliance on external signals. Processing systems configured to analyze route features may compute pose estimates dynamically, supporting precise navigation in environments where GNSS signals degrade. By integrating AVL with onboard navigation systems, aerial vehicles may operate with greater resilience across diverse mission scenarios. Future advancements in AVL technologies, including improvements in image recognition, multi-sensor fusion, and adaptive processing algorithms, may further optimize pose determination, expanding the potential applications of aerial vehicles in both civilian and defense sectors.

The embodiments may include a neurally assisted surveying in real-time (NASR) compute and sensor module configured to determine pose information using AVL of route features. The NASR compute and sensor module may integrate AVL-derived pose data with pose information obtained from other sources when available. In addition, the module may detect unreliable pose data, allowing the aerial vehicle to discard affected data and maintain operational accuracy in response to identifying compromised pose information.

Some embodiments may include navigation systems and ariel vehicles configured to determine pose information using AVL of route features without relying on pre-stored map images. These embodiments may reduce onboard storage requirements and may shift computationally intensive mission preparation to ground control. Offloading AVL data processing to ground control may improve efficiency by leveraging external computational resources and reducing power consumption onboard the aerial vehicle.

Some embodiments may include methods for controlling the flight of an aerial vehicle, which may include determining whether the aerial vehicle is operating (e.g., based on sensor data from power systems, flight control modules, and sensors, etc.), retrieving pose data from a GNSS receiver, an IMU, and a NASR compute and sensor module, validating the retrieved pose data (e.g., by comparing it to prior pose estimates and applying a checksum or threshold comparison for inconsistencies, etc.), discarding any pose data determined to be compromised based on the validation result, combining valid pose data from at least two of the GNSS receiver, IMU, and NASR module to generate unified pose data (e.g., using a sensor fusion technique, an Extended Kalman Filter (EKF), etc.) that includes enhanced position and orientation estimates, determining whether the unified pose data is aligned with the predefined flight route, and making necessary adjustments to the aerial vehicle's heading, altitude, or speed based on any deviations from the predefined flight route. In some embodiments, the methods may further include adjusting the aerial vehicle's control surfaces and/or thrust in response to the computed adjustments or pausing the system or entering a low power mode to reduce power consumption when no adjustments are needed. In some embodiments, pausing or sleeping the system may include reducing the processing frequency of the system to conserve power while maintaining the ability to respond to sensor data or deviations from the route and/or entering a low-power state that suspends non-essential computations but allows the system to quickly resume full functionality upon detecting new sensor data or deviation from the route.

Some embodiments may include methods of preparing an aerial vehicle for a mission so that the aerial vehicle may navigate the predefined route with reliable pose estimation and minimal computational overhead. These methods may include receiving mission requirements (e.g., an origin, a destination, zero or more waypoints, a threshold score, aerial vehicle capabilities, etc.) from a user or a remote processor, calculating a route based on the mission requirements, retrieving one or more georeferenced map images that represent the route (where each pixel is mapped to a geographic location using a coordinate transformation/mapping function), dividing the retrieved georeferenced map images into tiles, determining tile overlap, the processing power, storage capacity of the aerial vehicle's sensor module, or the route distance, determining the type of pipeline to be used based on the aerial vehicle details, selecting the determined type of pipeline (e.g., a keypoint-based pipeline, a template-based pipeline, or another type of pipeline), generating tile features using the selected pipeline type, adding the generated tile features to a route features data structure that includes the features for every tile along the route, and deploy/send the route features data structure and mission parameters to the aerial vehicle for use during mission execution.

In some embodiments, the processing system may be configured to retrieve map images from a repository and perform georeferencing using an affine transformation function that maps pixel locations in the images to geographic coordinates. In some embodiments, the processing system may divide the map images into tiles based on the aerial vehicle's capabilities. In some embodiments, the processing system may define or set the tile size and overlap to provide adequate coverage of the route while maintaining computational efficiency. In some embodiments, the processing system may determine the tile overlap size based on the route distance, the aerial vehicle speed, and the computational power of the NASR compute and sensor module.

In some embodiments, the processing system may determine whether a pipeline type is available by evaluating predefined conditions based on aerial vehicle specifications, including model and capabilities, which influence the available processing power and required route precision. In some embodiments, the processing system may generate an empty route features data structure in response to determining that there are no valid pipelines available. The empty route features data structure may indicate that the aerial vehicle cannot be provided with accurate pose data for the mission.

In some embodiments, generating tile features may include using a keypoint-based pipeline to detect identifiable features in the map tiles. In some embodiments, generating tile features using a keypoint-based pipeline may include detecting keypoints in the map images and extracting their features to represent the route. In some embodiments, the processing system may determine whether to use a template-based pipeline or another pipeline type by assessing the terrain complexity and the route features. The processing system may select a pipeline that optimizes performance based on available resources. The processing system may generate route features based on the selected pipeline type and may store the generated features in a data structure suitable for use in the aerial vehicle (e.g., by structuring the data for efficient use during mission execution, reduced storage and processing requirements, etc.).

Some embodiments may include methods of determining a pose of an aerial vehicle during a mission, which may include receiving, by a processing system in a NASR compute and sensor module, mission parameters comprising a route, route features, a threshold score, and a coordinate mapping function, capturing a query image of an environment using one or more cameras in the aerial vehicle, extracting query image features from the query image, matching the query image features to tile features stored in a route features data structure to identify a best-matching tile, determining pixel coordinates of the aerial vehicle within the best-matching tile, calculating a pixel coordinate score for the pixel coordinates of the aerial vehicle, determining whether the pixel coordinate score satisfies a threshold score, determining a pose of the aerial vehicle using the pixel coordinates and the coordinate mapping function in response to determining that the pixel coordinate score satisfies the threshold score, and transmitting the pose of the aerial vehicle to a flight control computer in the aerial vehicle.

Some embodiments may include methods of generating a pose using a NASR compute and sensor module in an aerial vehicle, which may include receiving, by a processing system in the NASR compute and sensor module, mission parameters including a route, route features, a threshold score, and a coordinate mapping function (the mission parameters being received from a ground control system or retrieved from onboard storage), determining whether the aerial vehicle is operating (e.g., based on power status, sensor availability, flight control system activity, etc.), capturing a query image using at least one onboard camera in response to determining that the aerial vehicle is operating, normalizing the query image by performing at least one of: i) adjusting exposure levels, ii) correcting image focus, iii) modifying image temperature, iv) filtering noise, v) correcting lens distortion, retrieving orientation information of the aerial vehicle from an onboard IMU, adjusting the normalized query image based on the retrieved orientation information by rotating the image according to the aerial vehicle's roll, pitch, or yaw, resizing the image according to the aerial vehicle's altitude, and/or performing ortho-rectification to compensate for perspective distortion, computing query image features using a tile matching pipeline configured to process image features, matching the query image features to preprocessed tile features stored in a route features data structure to determine a best matching tile, determining pixel coordinates of the aerial vehicle based on the best matching tile and its associated coordinate mapping function, calculating a confidence score for the determined pixel coordinates and comparing the confidence score to the threshold score, rejecting the determined pixel coordinates if the confidence score is below the threshold score and resuming query image capture operations (e.g., capturing a query image using at least one onboard camera, etc.), determining a pose of the aerial vehicle based on the pixel coordinates and the coordinate mapping function in response to the confidence score meeting or exceeding the threshold score, transmitting the determined pose to an onboard flight control computer, and adjusting a time interval before capturing a next query image based on at least one of: i) the capture rate of the onboard camera, ii) the processing speed of the NASR compute and sensor module, iii) the aerial vehicle's velocity, iv) the dimensions of the tiles in the route features data structure.

In some embodiments, the tile matching pipeline may be selected from a keypoint-based pipeline that extracts and indexes distinguishable features from image tiles, a template-based pipeline that segments image tiles into predefined patterns optimized for correlation-based matching, and a deep-learning-based pipeline that applies a neural network model to extract image features using spectral, texture, or shape analysis.

In some embodiments, determining the best matching tile may include computing similarity scores between the query image features and multiple candidate tiles, selecting a tile that has a similarity score above a predetermined threshold, and refining the matching process by adjusting for scale, rotation, or perspective changes based on environmental factors.

In some embodiments computing the confidence score may include evaluating the spatial alignment between the matched query image features and the tile features, analyzing the consistency of the pixel coordinates across multiple query images, and applying a probabilistic model to assess the likelihood that the determined pixel coordinates are accurate.

In some embodiments, the processing system may be further configured to adjust the time interval for query image capture based on aerial vehicle velocity, processing speed, or tile size, and store historical pose data for adaptive learning and improved localization accuracy over time.

Some embodiments may include methods of determining a pose of an aerial vehicle using a keypoint-based pipeline in a NASR compute and sensor module, which may include capturing a query image using a camera onboard the aerial vehicle, computing query image features by detecting keypoints in the query image and generating descriptors for the detected keypoints, determining candidate tile features based on a previously determined pose of the aerial vehicle (selecting candidate tile features from tiles near a previously determined pose (if available) or selecting candidate tile features from route features if a previously determined pose is not available), matching query image keypoints to tile keypoints (e.g., by selecting an unprocessed candidate tile, selecting an unprocessed query image keypoint, and comparing the descriptor of the query image keypoint to descriptors of keypoints in the candidate tile features to identify a best-matching candidate tile keypoint), computing a candidate tile score for each candidate tile based on descriptor distances between query image keypoints and corresponding candidate tile keypoints, selecting a best candidate tile by identifying the candidate tile with the lowest candidate tile score, generating a homography matrix based on matched keypoints in the query image and the best candidate tile, determining the pixel coordinates of the aerial vehicle by applying the homography matrix to the center of the query image, mapping the pixel coordinates to geographic coordinates using a coordinate mapping function, and transmitting the determined pose to a flight control computer in the aerial vehicle.

Some embodiments may include methods of determining a pose of an aerial vehicle that include receiving, by a NASR compute and sensor module, mission parameters defining a flight route (the mission parameters including route features, a threshold score, and a coordinate mapping function), capturing, using a camera onboard the aerial vehicle, a query image representing a scene beneath the aerial vehicle, computing query image features by detecting keypoints in the query image, determining, based on stored data, whether a previously determined pose for the aerial vehicle is available, retrieving candidate tile features corresponding to the pose in response to determining that a previously determined pose is available, retrieving candidate tile features corresponding to the route features in response to determining that a previously determined pose is not available, matching query image keypoints to candidate tile keypoints (e.g., by selecting a candidate tile keypoint whose descriptor is closest to the query image keypoint descriptor and computing a candidate tile score based on the similarity of matched keypoints), selecting, from multiple candidate tiles, the best candidate tile based on the lowest candidate tile score, generating a homography matrix to transform pixel coordinates in the query image into corresponding pixel coordinates in the best candidate tile, determining a pixel location of the aerial vehicle in the best candidate tile, calculating the aerial vehicle's pose by applying the coordinate mapping function to the pixel location, and providing the determined pose to a flight control computer for navigation adjustments.

In some embodiments, the method may include executing keypoint matching operations in parallel across multiple processing threads or processors. In some embodiments, computing the query image features may include applying a convolutional neural network to extract multi-dimensional feature representations from the query image. In some embodiments, determining the best candidate tile may include calculating a confidence score based on geometric consistency between query image keypoints and candidate tile keypoints. In some embodiments, the method may further include adjusting the homography matrix based on real-time IMU data to compensate for aerial vehicle pitch and roll.

Some embodiments may include methods of determining a pose of an aerial vehicle using a template-based pipeline, which may include capturing a query image of an area beneath the aerial vehicle using an onboard camera, generating a query image tensor by performing inference on the query image using a convolutional neural network (CNN), determining candidate tile features based on a previously determined pose of the aerial vehicle or route features along a predefined flight path (if no previously determined pose is available), performing template-based feature matching by convoluting the query image tensor with each candidate tile feature to generate a probability map, selecting pixel coordinates of the aerial vehicle based on the highest probability score within the probability maps across all candidate tile features, determining a geographic pose of the aerial vehicle by applying a coordinate mapping function to the selected pixel coordinates, and transmitting the geographic pose to a flight control computer to assist in aerial vehicle navigation.

Some embodiments may include methods of generating a pose of an aerial vehicle using a template-based pipeline executed by a NASR compute and sensor module, which may include capturing a query image using an onboard imaging system in the aerial vehicle, generating a tensor for the query image by performing inference using a convolutional neural network (CNN), determining whether a previously determined pose for the aerial vehicle is available, selecting candidate tile features based on the previously determined pose (if a previously determined pose is available) or selecting candidate tile features from stored route features (if a previously determined pose is not available), determining whether there are unprocessed candidate tile features, computing a probability map for each unprocessed candidate tile feature by convoluting the query image tensor with a candidate tile tensor (the probability map assigning a probability score to pixel coordinates in the candidate tile), identifying the best candidate tile based on the probability scores, determining pixel coordinates of the aerial vehicle in the best candidate tile by selecting the pixel coordinates with the highest probability score, computing a homography matrix based on the best candidate tile, transforming the pixel coordinates of the aerial vehicle in the query image using the homography matrix to obtain geographic coordinates, and transmitting the computed pose to a flight control computer in the aerial vehicle.

In some embodiments, the method may include normalizing the query image prior to generating the tensor. In some embodiments, the normalizing may include adjusting exposure, focus, noise, or lens distortion, and applying dynamic image adjustments based on orientation data from an IMU, including rotating the query image to compensate for aerial vehicle orientation, resizing the query image based on altitude, and applying orthorectification based on pitch and roll data.

In some embodiments, selecting candidate tile features based on a previously determined pose may include identifying a set of tiles surrounding the previously determined pose, and extracting candidate tile features from the identified tiles to reduce the search space. In some embodiments, selecting candidate tile features from stored route features may include extracting all available route features as candidate tile features, and performing a brute-force search across the extracted candidate tile features in the absence of a previously determined pose.

In some embodiments, computing probability maps for candidate tiles may be performed in parallel for multiple candidate tiles to improve processing efficiency. In some embodiments, computing the homography matrix may include identifying keypoint matches between the query image and the best candidate tile, and applying a homography estimation algorithm. In some embodiments, the homography estimation algorithm may include random sample consensus (RANSAC), direct linear transforms, or least squares estimation.

In some embodiments, transforming pixel coordinates of the aerial vehicle using the homography matrix may include determining a pixel location at the center of the query image, and applying the homography matrix to the pixel location to compute the corresponding pixel coordinates in the best candidate tile. In some embodiments, transforming pixel coordinates to geographic coordinates may include applying a coordinate mapping function to convert the pixel coordinates in the best candidate tile to latitude and longitude values.

In some embodiments, the methods may include determining a pause duration between capturing query images based on the camera's frame capture rate, the processing speed of the NASR compute and sensor module, the velocity of the aerial vehicle, and/or the tile resolution.

FIG. 1 is a block diagram illustrating various components of an example aerial vehicle deployment 100 suitable for use with various embodiments. In the example illustrated in FIG. 1, components 102a and 102b are aerial vehicles. Specifically, aerial vehicle 102a is a rotary-wing drone, and aerial vehicle 102b is a fixed-wing UAV. Aerial vehicles 102a and 102b may communicate with a pre-flight planning system that is part of a ground control 104. These communications may occur using a wired connection or a wireless connection (e.g., connection 108 with aerial vehicle 102b). The wireless connection 108 may utilize a public network (e.g., a 5G network). Ground control 104 may communicate with one or more repositories 106, and these repositories 106 may be internal to the ground control 104 or externally accessible over a network (e.g., the Internet). Aerial vehicle 102a may travel along route 110a from an origin at the ground control 104 to a destination 112. Similarly, aerial vehicle 102b may travel along route 110b from a different origin to the same destination 112. Aerial vehicles 102a, 102b may pass through zero or more waypoints between their route origins and route destinations.

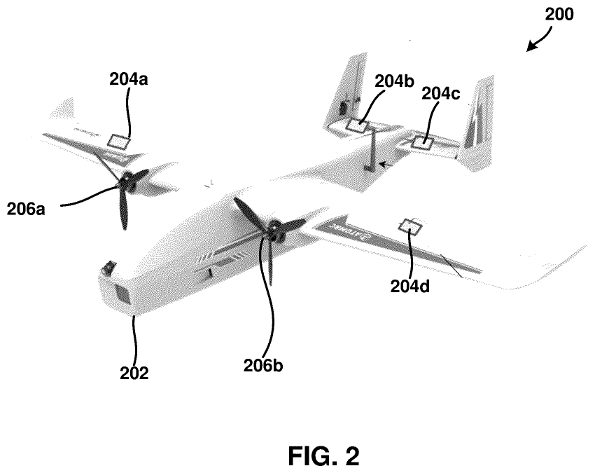

FIG. 2 is a block diagram illustrating an aerial vehicle 200 suitable for implementing some embodiments. Aerial vehicle 200 includes a NASR compute and sensor module on its underside (not visible in FIG. 2). Aerial vehicle 200 may include multiple control surfaces 204a-204d and a thrust mechanism 206a, 206b. In an enhanced embodiment, aerial vehicle 200 may include multiple external antennae affixed to different parts of the aerial vehicle to provide increased redundancy.

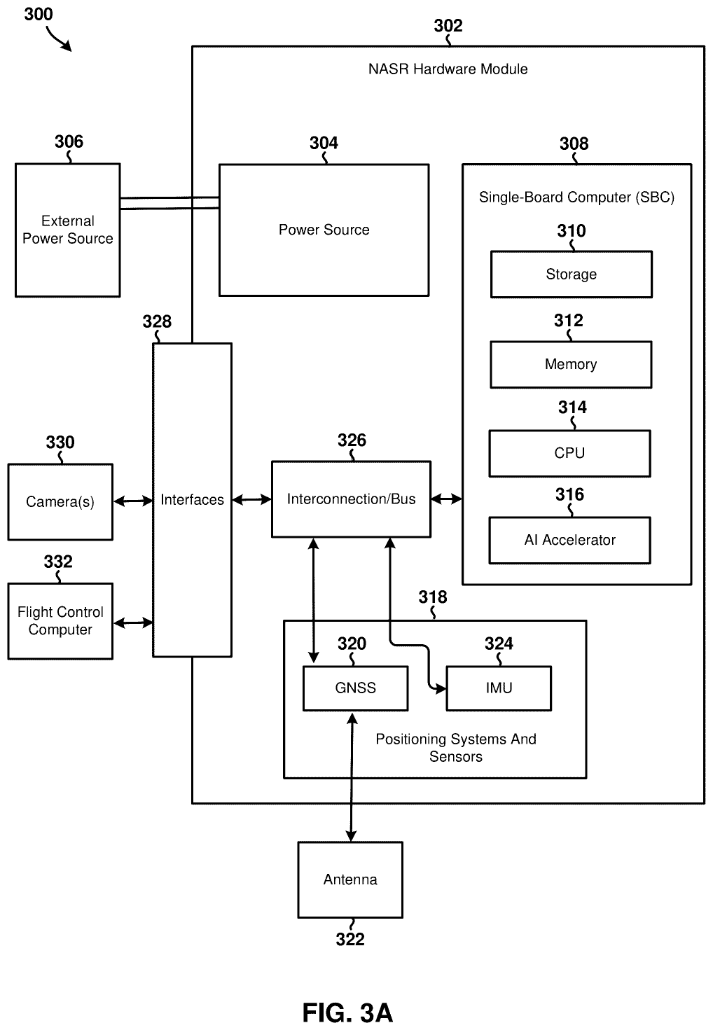

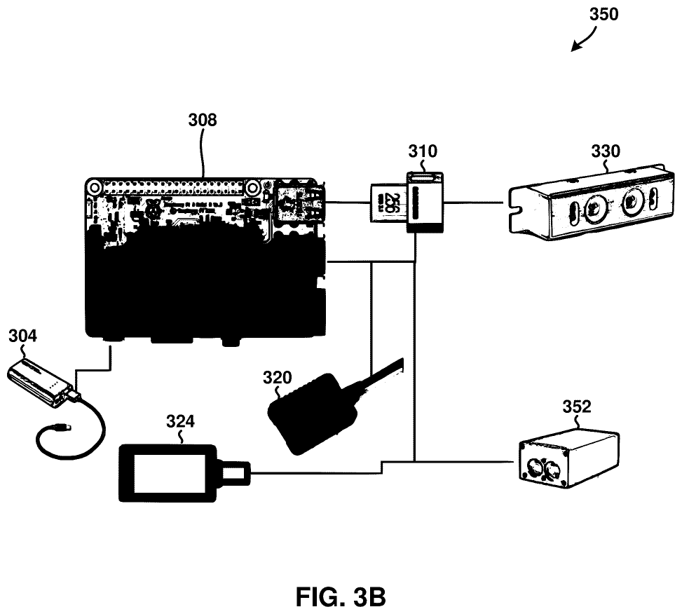

FIG. 3A is a block diagram illustrating a system 300 that includes a neurally assisted surveying in real-time (NASR) hardware module 302 suitable for use with various embodiments. In the example illustrated in FIG. 3A, the system 300 includes the NASR hardware module 302, external power source 306, camera(s) 330, flight control computer 332, and antenna 322. The NASR hardware module 302 may include a power source 304, a single-board computer (SBC) 308, interconnection/bus 326, interfaces 328, and positioning systems and sensors 318. The SBC 308 may include storage 310, memory 312, a CPU 314, and an AI accelerator 316. The positioning systems and sensors 318 may include a GNSS 320 and an IMU 324. The GNSS 320 may receive signals via the antenna 322. The interconnection/bus 326 may facilitate communication between components within the NASR hardware module 302 and external devices via the interfaces 328, which may be coupled to the camera(s) 330 and the flight control computer 332.

The external power source 306 may be configured to supply electrical power to the NASR hardware module 302. The external power source 306 may be a battery, fuel cell, or another power-generating unit that supports prolonged operation in field environments. The power source 306 may connect to the NASR hardware module 302 through dedicated power lines and/or otherwise provide energy to the power source 304 within the NASR hardware module 302.

The power source 304 may be configured to regulate and distribute electrical power within the NASR hardware module 302. The power source 304 may receive input from the external power source 306 and convert the received energy into appropriate voltage levels required by system components, including the single-board computer 308 and the positioning systems and sensors 318. In some embodiments, the power source 304 may be a battery.

The single-board computer (SBC) 308 may be configured to process data and execute computational tasks required for the NASR hardware module 302. The SBC 308 may manage data flow between system components and perform real-time processing for navigation, control, and data analysis. The SBC 308 may execute embedded software that governs decision-making processes and system responses. The SBC 308 may interface with storage 310, memory 312, the CPU 314, and the AI accelerator 316 to perform complex calculations.

The storage 310 may be configured to store mission data, system logs, and operational parameters required by the NASR hardware module 302. The storage 310 may include non-volatile memory such as solid-state drives (SSD) or flash storage to retain data even when power is removed. The storage 310 may archive recorded sensor data, including GNSS logs and IMU measurements, for post-mission analysis or real-time access by the flight control computer 332.

The memory 312 may be configured to provide temporary data storage for system operations within the NASR hardware module 302. The memory 312 may include volatile memory such as random-access memory (RAM) to facilitate high-speed data access by the SBC 308. The memory 312 may store intermediate computational results, sensor data buffers, and runtime variables for mission execution.

The CPU 314 may be configured to execute instructions and control the operation of the NASR hardware module 302. The CPU 314 may process data received from the positioning systems and sensors 318 and manage communication with external devices via the interconnection/bus 326. The CPU 314 may execute navigation algorithms, process camera feeds, and coordinate data transmission between system components. The CPU 314 may work in conjunction with the AI accelerator 316 to optimize performance for computationally intensive tasks.

The AI accelerator 316 may be configured to enhance processing efficiency for machine learning and artificial intelligence applications within the NASR hardware module 302. The AI accelerator 316 may offload computational workloads from the CPU 314 to improve the execution speed of complex algorithms. The AI accelerator 316 may process image data from the camera(s) 330, perform real-time object recognition, and assist in autonomous decision-making. The AI accelerator 316 may be optimized for low-power, high-performance computations to support deep learning models.

The interconnection/bus 326 may be configured to facilitate communication between system components within the NASR hardware module 302. The interconnection/bus 326 may provide high-speed data transfer between the SBC 308, positioning systems and sensors 318, and interfaces 328. The interconnection/bus 326 may support multiple communication protocols, including serial, parallel, and high-speed data interfaces for the integration of the hardware components.

The interfaces 328 may be configured to enable data exchange between the NASR hardware module 302 and external systems. The interfaces 328 may connect to external components such as the camera(s) 330 and flight control computer 332. The interfaces 328 may support wired and wireless communication protocols, including USB, Ethernet, and serial communication, to allow data transmission between the NASR hardware module 302 and other onboard avionics.

The positioning systems and sensors 318 may be configured to provide real-time navigation and spatial awareness for the NASR hardware module 302. The positioning systems and sensors 318 may include the GNSS 320 and IMU 324, which may work together to determine the system's position, velocity, and orientation. The positioning systems and sensors 318 may continuously collect and process location data to enhance situational awareness and support autonomous navigation.

The GNSS 320 may be configured to receive satellite-based positioning signals and determine the geographic location of the NASR hardware module 302. The GNSS 320 may acquire signals from global navigation satellite systems, including GPS, Galileo, or GLONASS, to compute latitude, longitude, and altitude. The GNSS 320 may process real-time corrections from external sources to improve positional accuracy. The GNSS 320 may receive signals via the antenna 322.

The IMU 324 may be configured to measure acceleration, angular velocity, and orientation changes of the NASR hardware module 302. The IMU 324 may include gyroscopes, accelerometers, and magnetometers to track movement and detect changes in position. In some embodiments, the IMU 324 may supplement GNSS data to provide continuous navigation information, particularly in environments where satellite signals are obstructed. The IMU 324 may communicate with the interconnection/bus 326 to transmit motion data to the SBC 308.

The antenna 322 may be configured to facilitate the reception of GNSS signals for the NASR hardware module 302. In some embodiments, the antenna 322 may be configured for high-sensitivity signal acquisition for reliable communication with multiple satellite constellations. In some embodiments, the antenna 322 may be mounted externally to enhance line-of-sight reception and reduce signal interference.

The camera(s) 330 may be configured to capture visual data for use in navigation, obstacle detection, and environmental analysis. The camera(s) 330 may provide high-resolution imagery that supports real-time surveying, object recognition, and situational awareness. The camera(s) 330 may interface with the SBC 308 via the interfaces 328, allowing image data to be processed by the AI accelerator 316 for feature extraction and analysis.

The flight control computer 332 may be configured to manage flight operations and control inputs for the aerial vehicle. For example, the flight control computer 332 may be configured to adjust the control surfaces (e.g., 204a-204d with reference to FIG. 2) and thrust mechanism (e.g., 206a, 206b with reference to FIG. 2) of the aerial vehicle (e.g., aerial vehicle 200 with reference to FIG. 2). The flight control computer 332 may receive navigation data from the NASR hardware module 302 and use this information to adjust flight parameters. The flight control computer 332 may communicate with the SBC 308 to execute autonomous flight maneuvers and respond to mission requirements. The flight control computer 332 may integrate with external avionics to ensure stable and precise flight control.

FIG. 3B is a block diagram illustrating a system 350 that includes or integrates a NASR compute and sensor module in accordance with some embodiments. In the example illustrated in FIG. 3B, the system 350 includes a power source 304, an SBC 308, persistent storage 310, a GNSS receiver 320, an IMU 324, a camera module 330, and various sensors 352. The sensors 352 may include altitude measurement systems such as altimeters, which may be implemented using laser-based, pressure-based, radar-based, or other altitude sensing technologies. The system 350 may support additional environmental and navigational sensors, including barometers, magnetometers, and spectrometers, depending on operational requirements.

The power source 304 may include a rechargeable or non-rechargeable power supply (e.g., a lithium-based battery, fuel cell, supercapacitor, etc.) depending on energy demands and deployment conditions. The SBC 308 may be implemented using an embedded computing platform such as a Raspberry Pi, NVIDIA Jetson, or another single-board computing system capable of supporting real-time data processing and sensor fusion. The persistent storage 310 may include solid-state drives (SSDs), flash storage, or other non-volatile memory solutions that provide data retention and rapid retrieval capabilities. The GNSS receiver 320 may support various satellite positioning systems, including GPS, Galileo, and GLONASS, and may interface with the system using USB, SPI, or other communication protocols. The IMU 324 may provide motion tracking and orientation data, integrating gyroscopes, accelerometers, and magnetometers to enhance navigation and stability. The camera module 330 may include multiple imaging sensors (e.g., visible light, infrared, hyperspectral, or thermal cameras, etc.) to support a wide range of imaging and analytical functions. In some embodiments, the camera module 330 may include complementary metal-oxide-semiconductor (CMOS)-based cameras.

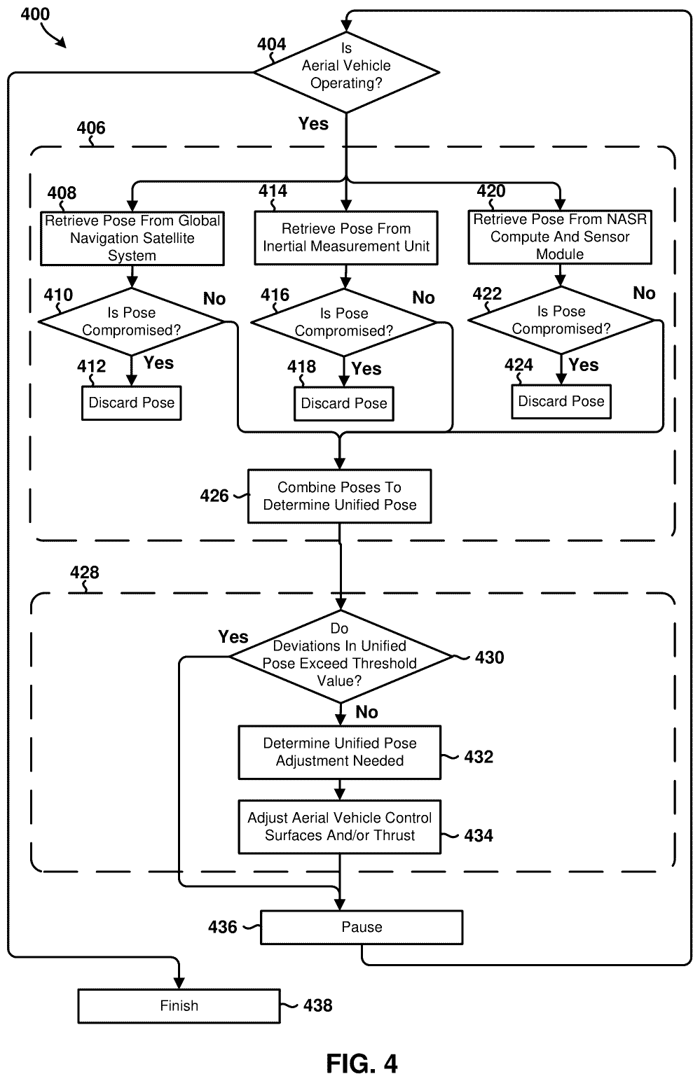

FIG. 4 is a process flow diagram illustrating a method 400 of controlling the flight of an aerial vehicle in accordance with some embodiments. Method 400 may be performed in a computing device (e.g., by flight control computer 332 with reference to FIG. 3A) by a processing system that includes one or more processors, components or subsystems discussed in this application. Means for performing the functions of the operations in method 400 may include these processors, components, and subsystems. One or more processors within the processing system may be configured with software or firmware to perform some or all of the operations of method 400.

With reference to FIGS. 1-4, in determination block 404, the processing system may determine whether the aerial vehicle is operating. The system may assess power availability, flight control system status, and sensor functionality to make this determination. In some embodiments, the processing system may retrieve data from power management modules, avionics controllers, and onboard sensors to confirm operational status. For example, the processing system may verify that the propulsion system is active and receiving power from the power source 304 or an external energy source 306.

In response to determining that the aerial vehicle is not operating (i.e., determination block 404=“No”), the process may terminate in block 438. In response to determining that the aerial vehicle is operating (i.e., determination block 404=“Yes”), the processing system may determine the current pose of the aerial vehicle in block 406.

In block 406, the processing system may perform the operations in blocks 408-426 to determine the current pose of the aerial vehicle using one or more different methods or sensor-based techniques (depending on the capabilities of the aerial vehicle). The processing system may perform the operations of multiple different methods or sensor-based techniques concurrently or in parallel. As discussed in detail below with reference to blocks 408-426, the processing system may retrieve pose estimates from different sources/sensors, validate sensor data, and combine the data to generate a unified pose estimate value.

For example, in block 408, the processing system may retrieve a GNSS pose estimate from a GNSS receiver (e.g., GNSS receiver 320 in FIG. 3A). The GNSS receiver may determine the geographic position of the aerial vehicle by processing satellite signals from one or more satellite constellations (e.g., GPS, Galileo, or GLONASS). GNSS-based pose estimates may be highly accurate when the aerial vehicle operates in an environment with an unobstructed view of the sky. However, GNSS signals may degrade due to multipath interference, atmospheric effects, or signal blockage in obstructed environments (e.g., tunnels, dense forested areas, urban canyons or space between high-rise buildings, etc.).

For example, when the aerial vehicle is flying over an open field, the GNSS receiver may provide accurate geographic coordinates based on direct satellite communication. However, when the aerial vehicle enters a confined space between high-rise buildings, reflected signals may introduce inaccuracies, leading to a compromised GNSS pose estimate.

In determination block 410, the processing system may evaluate the GNSS pose estimate to determine whether it is compromised. The system may compare the GNSS pose estimate to previous estimates and assess whether deviations exceed an acceptable threshold. The processing system may also analyze GNSS signal strength, satellite geometry, and error correction parameters to identify inconsistencies. The processing system may classify the GNSS pose estimate as compromised in response to detecting abrupt positional shifts, excessive signal noise, or loss of satellite lock.

In response to determining that the GNSS pose estimate is compromised (i.e., determination block 410=“Yes”), the processing system may discard the GNSS pose in block 412 to prevent it from affecting the vehicle's navigation accuracy. The processing system may then rely on alternative pose estimates, such as those generated by the IMU or the NASR compute and sensor module. If sufficient data from other sources is unavailable, the system may trigger a recalibration process to restore reliable pose estimation.

In block 414, the processing system may retrieve an IMU pose estimate from an IMU (e.g., IMU 324 illustrated and described with reference to FIG. 3A). The IMU may provide motion and orientation data based on measurements from sensors such as accelerometers, gyroscopes, and magnetometers. Unlike GNSS, the IMU does not rely on external signals, making it useful in environments in which the GNSS signal is compromised or unreliable. However, IMU-based pose estimates may accumulate drift over time due to integration errors in acceleration and angular velocity measurements.

For example, if the aerial vehicle is flying in a stable environment with minimal external disturbances, the IMU may provide reliable short-term pose estimates. However, as the flight duration increases, small measurement inaccuracies may accumulate, leading to positional drift that reduces the accuracy of the estimated pose.

In determination block 416, the processing system may determine whether the received IMU pose estimate is compromised. For example, the processing system may compare the IMU pose to previously recorded estimates and measure deviations exceeding a predefined drift threshold. The processing system may also analyze sensor health diagnostics, including accelerometer bias and gyroscope drift rate, to evaluate and determine data integrity. The processing system may classify the IMU pose estimate as compromised in response to determining that there IMU pose data includes excessive drift or deviates significantly from expected motion patterns.

In response to determining that the IMU pose estimate is compromised (i.e., determination block 416=“Yes”), the processing system may discard the IMU pose in block 418. The system may then rely on GNSS or NASR-based pose estimates to mitigate errors. In some embodiments, the processing system may execute a recalibration procedure using valid sensor data to correct IMU drift and restore pose accuracy.

In block 420, the processing system may retrieve a NASR pose estimate from the NASR compute and sensor module (e.g., NASR hardware module 302, SBC 308, etc.). The NASR module may estimate the aerial vehicle's pose based on environmental sensing, which may include optical, LiDAR, or radar-based terrain mapping. In some embodiments, the processing system may use machine vision or feature tracking algorithms (e.g., via the AI accelerator 316, etc.) to identify landmarks and estimate position and orientation.

For example, the NASR module may analyze camera imagery to detect and track ground features (e.g., roads, buildings, natural landmarks, etc.). The processing system may estimate the aerial vehicle's pose by matching these detected features to a pre-existing geospatial map. However, the accuracy of NASR-based pose estimation may be affected by environmental factors such as lighting conditions, terrain uniformity, or sensor occlusion.

In determination block 422, the processing system may determine whether the received NASR pose estimate is compromised. For example, the processing system may compare NASR pose estimates to previously recorded positions and assess discrepancies beyond an acceptable threshold. The processing system may also analyze the confidence scores of feature detection algorithms and sensor fusion models to determine pose reliability. The system may classify the pose as compromised in response to determining that the NASR pose estimate exhibits large inconsistencies or deviates significantly from the other sensor data (e.g., IMU or GNSS data, etc.).

In response to determining that the NASR pose estimate is compromised (i.e., determination block 422=“Yes”), the processing system may discard the NASR pose estimate in block 424. The system may then rely on alternative pose estimates from other sensors to maintain navigation accuracy. In some embodiments, the system may execute a recalibration process using verified sensor data to refine NASR pose estimation and restore alignment with expected motion patterns.

The processing system may determine whether a received pose is compromised (e.g., in blocks 410, 416, and 422) by evaluating data integrity and consistency using multiple validation techniques. These techniques may include computing a checksum, comparing the received pose to a previously stored pose, and verifying whether changes exceed allowable thresholds.

For example, the processing system may compute a checksum for the received pose data to detect errors introduced by sensor malfunctions or data transmission issues. The checksum may be a mathematical value derived from the pose data that allows the processing system to verify data integrity. The processing system may determine that the pose is compromised in response to detecting a checksum mismatch, indicating possible data corruption.

The processing system may also compare the received pose with a previously recorded pose to assess whether changes in position or orientation exceed predefined thresholds. For example, the processing system may classify a GNSS pose as compromised if the computed position deviates from the previous pose by more than a predefined distance threshold (e.g., an unexpected jump of more than 50 meters within a one-second interval). Similarly, the system may determine that an IMU or NASR-based pose is compromised if the computed orientation change exceeds a predefined angular threshold (e.g., a deviation greater than 10 degrees over a short period that is inconsistent with expected vehicle motion).

In some embodiments, the processing system may use a combination of validation techniques to improve pose reliability. For example, if the checksum verification and threshold-based comparison both indicate discrepancies, the processing system may classify the received pose as compromised and discard it to prevent inaccurate navigation adjustments. If only one validation technique flags an inconsistency, the processing system may perform additional verification steps before deciding whether to discard or retain the pose.

In response to determining that at least two independent pose estimates are valid (i.e., at least two of determination blocks 410, 416, and 422=“No”), the processing system may combine the valid poses to generate a unified pose in block 426. The processing system may integrate pose data from multiple sources, such as the GNSS receiver, IMU, and NASR compute and sensor module, to improve the overall accuracy of the aerial vehicle's position and orientation. The processing system may assign different weights to each data source based on its reliability in the current operating environment. For example, if GNSS signals are strong and consistent, the processing system may prioritize GNSS-based position estimates. Conversely, if the GNSS pose is unreliable due to signal degradation, the processing system may assign greater weight to IMU and NASR-based pose estimates.

In some embodiments, the processing system may implement an EKF or a similar sensor fusion algorithm to generate the unified pose estimate. The EKF may iteratively refine the pose estimate by incorporating new sensor data while accounting for measurement uncertainties and system dynamics. The processing system may use the EKF to combine GNSS, IMU, and NASR-based pose estimates to benefit from the strengths of each sensor, method, or technique while mitigating their respective limitations.

For example, the GNSS receiver may provide accurate position estimates but limited orientation data, while the IMU may provide reliable orientation estimates but accumulate drift over time. The NASR module may enhance situational awareness by identifying environmental landmarks and refining pose estimates based on terrain features. The EKF component may assign confidence levels to each data source and dynamically adjust their influence based on real-time conditions. If the GNSS pose remains stable, the EKF may use it as a primary reference while using the IMU to refine orientation. If the GNSS signal weakens, the EKF may rely more heavily on the IMU and NASR module for pose estimation.

In block 428, the processing system may perform the operations in blocks 430-434 to determine the necessary aerial vehicle adjustment. The processing system may compare the unified pose to the predefined route and determine whether adjustments are required to maintain the intended trajectory. If a deviation is detected, the processing system may compute the necessary corrections to heading, altitude, or velocity to return the aerial vehicle to the correct path.

For example, in determination block 430, the processing system may determine whether the unified pose aligns with the predefined route. The processing system may compare the vehicle's current position and orientation with the planned trajectory and assess whether the deviation exceeds an allowable threshold. The processing system may analyze multiple factors, including the expected flight path, real-time environmental conditions, and sensor tolerances, to determine whether corrective action is required.

In some embodiments, the processing system may allow a predefined tolerance zone around the route to account for minor deviations. For example, the processing system may define an allowable deviation radius of 500 meters from the planned path, accommodating small variations due to environmental conditions such as wind drift or minor inaccuracies in sensor data. If the vehicle's pose remains within this zone, the processing system may classify the deviation as acceptable and/or may not classify the pose estimate as compromised or initiate any corrective actions.

In response to determining that the unified pose deviates beyond the allowable threshold (i.e., determination block 430=“No”), the processing system may compute the necessary adjustments in block 432. The processing system may calculate the changes to the vehicle's heading, altitude, and velocity required to return to the planned trajectory. The processing system may factor in stability constraints and control limitations to make sure that the correction is smooth and does not induce instability or excessive oscillation.

In block 434, the processing system may execute the computed adjustments by modifying the control inputs of the aerial vehicle. For example, the processing system may generate control signals for aerodynamic control surfaces, such as the ailerons, rudder, and elevator in fixed-wing aircraft, or adjust rotor tilt and thrust levels in rotary-wing aircraft. The processing system may regulate thrust to manage acceleration and deceleration so that the vehicle transitions back to the correct path in a controlled manner.

In response to determining that the unified pose is within the acceptable range for the route (i.e., determination block 430=“Yes”), the processing system may forgo initiating corrective actions and proceed to block 436. The processing system may continue monitoring the pose and flight conditions while maintaining its current state. In some embodiments, the processing system may reduce its computational workload by entering a low-power monitoring state to conserve energy while retaining capabilities to promptly detect and address future deviations.

In block 436, the processing system may enter a pause or sleep state to improve power consumption. The processing system may reduce processor activity by lowering the clock frequency, suspending non-essential computations, or disabling certain subsystems that are not immediately required for flight control. The processing system may continue monitoring sensor inputs to detect changes that require reactivation. The processing system may resume full operation and perform the necessary adjustments in response to detecting a significant deviation or a new navigation command.

In response to determining that the aerial vehicle is not operating (i.e., determination block 404=“No”), the processing system may exit, end, terminate, or finish in block 438. The processing system may release allocated resources, store final flight data, and transition to an idle state. If the processing system is part of a larger networked flight control architecture, it may transmit a final status report to a ground control system before shutting down.

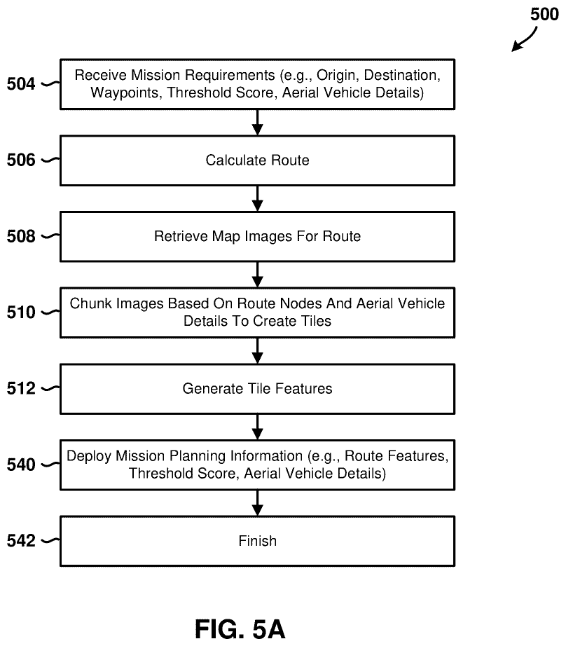

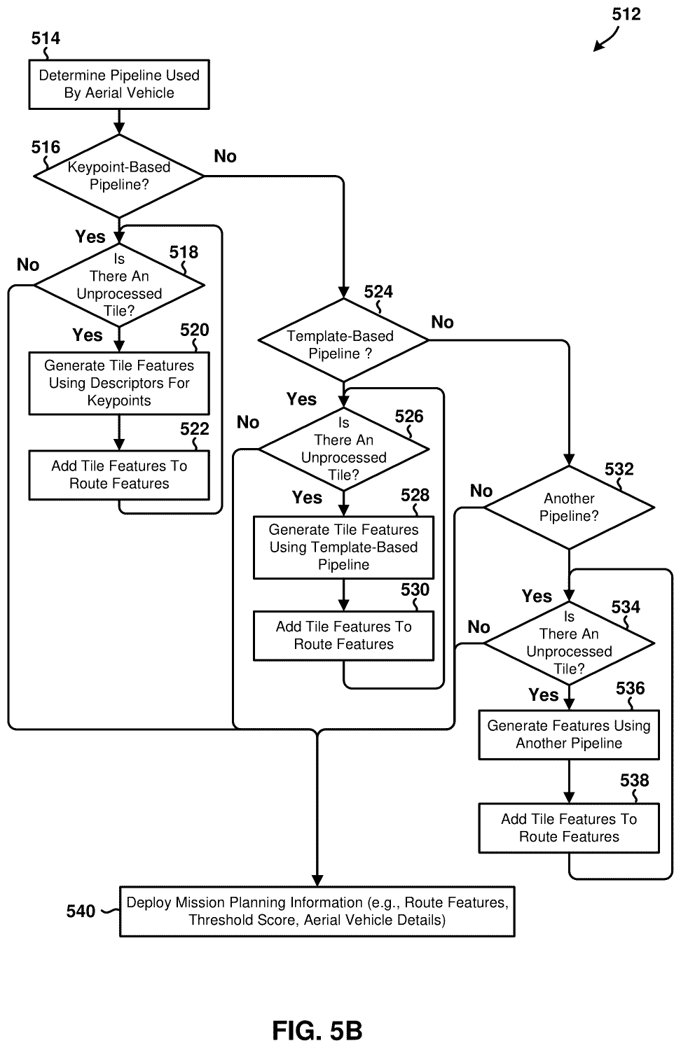

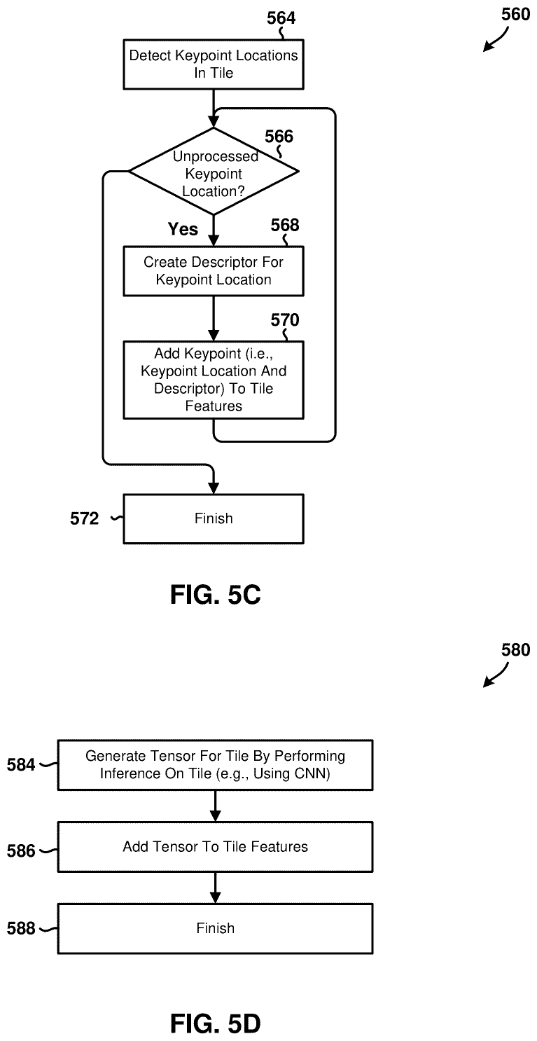

FIG. 5A-5D are process flow diagrams illustrating a method of preparing an aerial vehicle for a mission in accordance with some embodiments. Specifically, FIGS. 5A and 5B are process flow diagrams illustrating a method 500 of preparing an aerial vehicle for a mission using a specific pipeline in accordance with some embodiments. Method 500 may be performed by a processor or processing system in the ground control (e.g., by a pre-flight planning system that is part of a ground control 104 with reference to FIG. 1). Means for performing the functions of the operations in method 500 may include one or more processors, components or subsystems discussed in this application. One or more processors within the processing system may be configured with software or firmware to perform some or all of the operations of method 500.

With reference to FIGS. 1-5A, in block 504, the processing system may receive the mission requirements from an operator or a remote processor. The processing system may receive the mission details through a user interface in which the operator inputs the starting location, destination, and any optional waypoints along the route. If the mission details are provided through an API, the processing system may retrieve them in a structured format (e.g., JSON, XML, etc.) that includes the origin, destination, waypoints, and mission parameters, including weather conditions and flight restrictions. The processing system may obtain the mission requirements from a remote server by querying an external flight management platform for route details.

In some embodiments, the mission requirements may include an origin, a destination, one or more waypoints, a threshold score, and aerial vehicle details. The origin and destination may be specified as geographic coordinates. The waypoints may be defined as intermediate geographic coordinates that guide the aerial vehicle along the route. The threshold score may represent an operational parameter that determines the acceptable mission success criteria, such as the percentage of route coverage or environmental factors, including fuel efficiency and wind conditions, that must meet predefined benchmarks before the mission proceeds. The aerial vehicle details may be provided explicitly or by reference to a database entry containing the vehicle's make and model. In some embodiments, the processing system may query an internal or external repository using the aerial vehicle's model identifier to retrieve operational specifications, including maximum flight range, payload capacity, and sensor capabilities. The processing system may use these specifications to determine whether the planned route and mission parameters align with the aerial vehicle's operational constraints.

In block 506 the processing system may calculate the route for the aerial vehicle. For example, the processing system may use a route-planning algorithm to compute the optimal path between the origin and destination (while incorporating waypoints from the mission requirements, etc.). The processing system may evaluate factors such as path efficiency, fuel consumption, and airspace restrictions. If the route includes multiple no-fly zones, the processing system may apply a pathfinding algorithm to compute a trajectory that avoids restricted areas. The processing system may also incorporate the aerial vehicle's flight range, maximum speed, and power consumption to confirm that the planned route aligns with the vehicle's operational constraints.

In some embodiments, the processing system may initially compute a direct path from the origin to the destination and adjust the route by incorporating intermediate waypoints specified by the operator. Each waypoint may represent a geographic coordinate that directs the aerial vehicle along the intended path. The processing system may refine the route by considering factors such as energy efficiency and time-of-day restrictions. The processing system may also adjust the planned trajectory in response to real-time updates from external sources, including air traffic control directives or adverse weather conditions.

In some embodiments, the processing system may be configured to verify that the route does not exceed the aerial vehicle's operational range. If the flight range imposes a limitation, the processing system may compute intermediate stops for refueling or recharging based on available infrastructure along the route. The processing system may identify refueling stations, battery swap locations, or charging sites based on the aerial vehicle's power source.

In some embodiments, the processing system may be configured to retrieve static and dynamic data from external systems to improve route accuracy. The processing system may query databases or real-time data feeds to acquire airspace constraints, including restricted zones and temporary flight restrictions. In addition, the processing system may obtain real-time meteorological data (e.g., wind speed, direction, etc.) to assess environmental conditions that may influence fuel consumption and navigation efficiency. The processing system may integrate both static and dynamic data to determine an optimal route.

In some embodiments, the processing system may be configured to dynamically modify the planned route in response to changing conditions. The processing system may update the trajectory in response to determining that a temporary flight restriction alters airspace availability. The processing system may switch to terrain-based localization (e.g., by prioritizing environmental features extracted from map images) in response to detecting degradation in GNSS signal reliability. In some embodiments, the processing system may generate contingency routes before deployment to provide alternate paths that allow the aerial vehicle to navigate around obstacles without requiring real-time intervention.

In block 508, the processing system may retrieve one or more georeferenced map images that represent the entire route of the aerial vehicle. For example, the processing system may query an internal or external repository (e.g., repositories 106 with reference to FIG. 1) to obtain satellite imagery that covers the geographical region of interest (e.g., imagery corresponding to the geographic coordinates of the origin, destination, and any waypoints in the mission requirements, etc.). The processing system may retrieve high-resolution satellite images, terrain maps, or topographic maps that depict surface details such as buildings, roads, and other landmarks relevant to navigation.

In some embodiments, the processing system may acquire georeferenced images from an API-based mapping service or a cloud-based repository. The images may include detailed topographical data, infrastructure layouts, or environmental features. The processing system may retrieve these images in standard formats (e.g., JPEG, PNG, GeoTIFF, etc.) to maintain compatibility with geospatial analysis tools.

In some embodiments, the processing system may be configured to georeference the retrieved images by mapping pixel coordinates to geographic coordinates using a coordinate mapping function. In some embodiments, the processing system may apply an affine transformation to convert each pixel location to a spatial position based on known reference points. The transformation may account for variations in scale, rotation, and translation to align image data with real-world locations. In some embodiments, the processing system may refine the georeferencing accuracy by matching image features to stored geographic coordinates.

In some embodiments, the processing system may be configured to correct for distortions in satellite imagery by using polynomial transformations and spline-based warping techniques. For example, if the terrain includes elevation changes, the processing system may integrate digital elevation model data to adjust tile positions. The processing system may identify known landmarks in the map images and align them with reference data to improve positional accuracy. In some embodiments, the processing system may be configured to generate masks to segment the retrieved images into relevant areas.

As mentioned above, the map images may be georeferenced so that each pixel location (which may be defined using pixel coordinates) is mapped to a geographic location (which may be defined using geographic coordinates such as latitude and longitude) using a coordinate mapping function. For example, the processing system may use a georeferencing technique to map the pixel coordinates (u, v) of each map image to real-world geographic coordinates (latitude, longitude). The processing system may apply a coordinate mapping function to convert the pixel locations from image space to geographic space so that the map accurately reflects the location on Earth. The processing system may use a known georeferencing technique, such as matching known landmarks on the image to their real-world geographic coordinates, to achieve this mapping.

In some embodiments, in block 508, the processing system may retrieve one or more map images corresponding to the planned route and apply a coordinate mapping function to convert pixel coordinates to geographic coordinates. The processing system may correct for topographic distortions by applying polynomial transformations when the terrain includes hills or valleys. The processing system may use spline-based warping techniques to correct distortions in wide-angle satellite imagery. If the terrain includes elevation variations, the processing system may integrate digital elevation model data to adjust tile positions. In some embodiments, the processing system may refine georeferencing accuracy by aligning known landmarks in the map images with stored geographic coordinates.

In some embodiments, the processor may use an affine transformation A that converts a pixel location (u, v) into a spatial location (x, y), with a and e being scaling components, c and f being translation components, and a, b, d, and e being rotation components. For example, the processing system may apply an affine transformation matrix to adjust the coordinates of each pixel in the map image based on known spatial reference points. This transformation may correct for distortions in the image caused by the perspective or the curvature of the Earth so that each pixel's spatial location aligns with the correct geographic coordinates.

$$A = [ \begin{matrix}a & b & c \\ d & e & f \\ 0 & 0 & 1\end{matrix} ] [ \begin{matrix}x \\ y \\ 1\end{matrix} ] = A [ \begin{matrix}u \\ v \\ 1\end{matrix} ]$$

For example, the processing system may use scaling factors a and e to adjust for differences in image resolution, translation components c and f to adjust for the position of the image within the map, and rotation components a, b, d, and e to account for any tilt or rotation of the image. The resulting transformed coordinates (x, y) may be used to precisely map the image to the real-world geographic coordinates, allowing the processing system to align the map data with the route of the aerial vehicle.

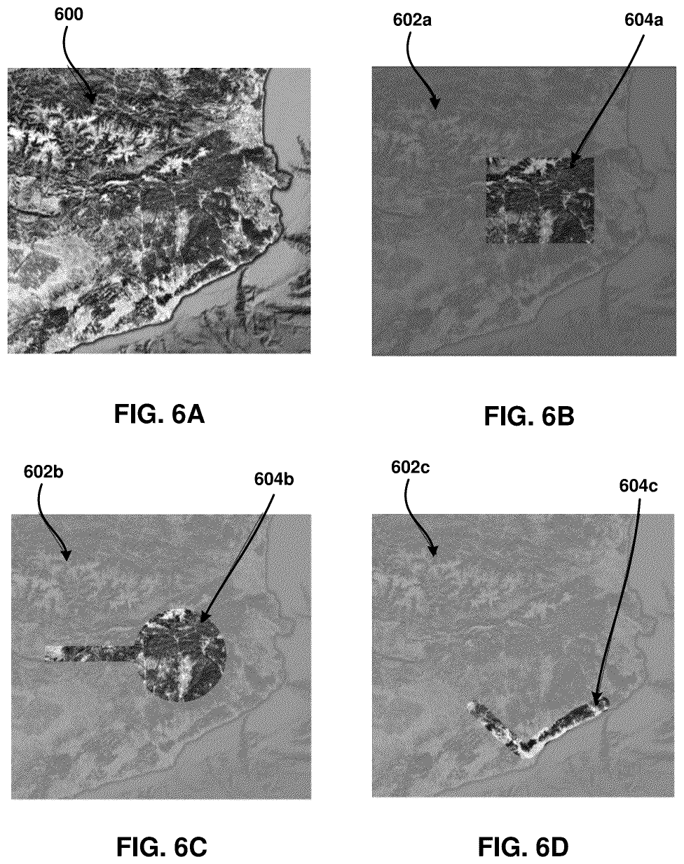

FIGS. 6A-6D are examples of map images and routes for use in accordance with some embodiments. FIG. 6A illustrates an area of interest containing unprocessed map data. FIG. 6B illustrates a mask applied to isolate a specific segment of the planned route. The processing system may use this mask to exclude irrelevant regions and retain the necessary data for navigation. FIG. 6C illustrates a circular mask that captures a broader region around a waypoint, and which allows the processing system to include additional reference points. FIG. 6D illustrates a mask that follows the route's curvature so that the map data corresponds precisely to the aerial vehicle's expected trajectory. The processing system may generate these masks dynamically based on flight parameters to improve efficiency.

More specifically, FIG. 6A illustrates how one or more map images, such as satellite photos, may be combined to cover an area of interest 600. This area may encompass the entire region from which map data is extracted, before any additional modifications (e.g., masks, etc.) are applied.

FIG. 6B illustrates how a mask 602a may be applied to the area of interest 600 to create an area 604a that includes a specific segment of the planned route. The processing system may apply the mask to filter out irrelevant portions of the map and retain only the area corresponding to the route segment. This mask may isolate the portion of the map required for navigation to allow the system to focus resources and processing on the relevant data.

FIG. 6C shows how mask 602b is applied to the area of interest 600, resulting in area 604b. In this example, the mask may take a circular shape to capture a broader region around a particular waypoint or a critical navigation segment of the route. This may allow for more precise targeting of relevant map data and is particularly useful for important areas like key waypoints or flight maneuvers.

FIG. 6D illustrates how mask 602c is applied to the area of interest 600 to create area 604c. In contrast to the circular or rectangular shapes of previous masks, this mask follows a curved or angular path to conform to the route's specific trajectory. The processing system may generate such a mask dynamically based on the expected flight path so that the map data retrieved precisely matches the route.

Returning to FIG. 5A, in block 510, the processing system may “chunk” the map images into smaller sections, referred to as tiles, by splitting or combining them based on the route and the aerial vehicle specifications. The processing system may analyze the geographic area covered by the route and determine tile dimensions based on the resolution of the map images, the vehicle's speed, memory capacity, and the level of detail required for navigation. The processing system may select tile sizes that enhance computational efficiency while providing sufficient levels of spatial accuracy.

The processing system may define tile boundaries along a uniform grid or align them with specific waypoints or route segments. For example, if the route spans 500 kilometers, the processing system may divide the map into 10-kilometer tiles to allow efficient processing by the aerial vehicle's onboard systems. The processing system may adjust tile sizes dynamically to accommodate varying terrain complexity or operational constraints.

The processing system may configure adjacent tiles to overlap to maintain continuity along the route. Overlapping tiles may prevent data loss at tile boundaries and improve the aerial vehicle's ability to transition between tiles without introducing navigation errors. For example, the processing system may define an overlap of 10%-20% to retain redundant data, improving positional accuracy when the aerial vehicle moves from one tile to another.

The processing system may adjust the overlap based on environmental conditions or the complexity of the route. A larger overlap may be used in areas with dense terrain features, such as urban environments or forests, where precise alignment between tiles is necessary for accurate localization. A smaller overlap may be sufficient for open landscapes, where fewer distinguishing features exist. The processing system may adjust tile overlap to balance redundancy and storage efficiency while maintaining reliable navigation data.

Thus, the overlapping region between adjacent tiles may help reduce errors or discrepancies at the boundaries. In some embodiments, the processing system may use the overlap to calculate smoother transitions between tiles, thus preventing data gaps that could affect route accuracy. The amount of overlap may be adjustable based on the aerial vehicle's operational environment and route complexity. A higher overlap may be used for areas with poor map data or challenging terrain (e.g., urban canyons, dense forests, etc.), while less overlap may be sufficient for less challenging terrain (e.g., open fields, straightforward routes, routes with fewer obstacles, etc.).

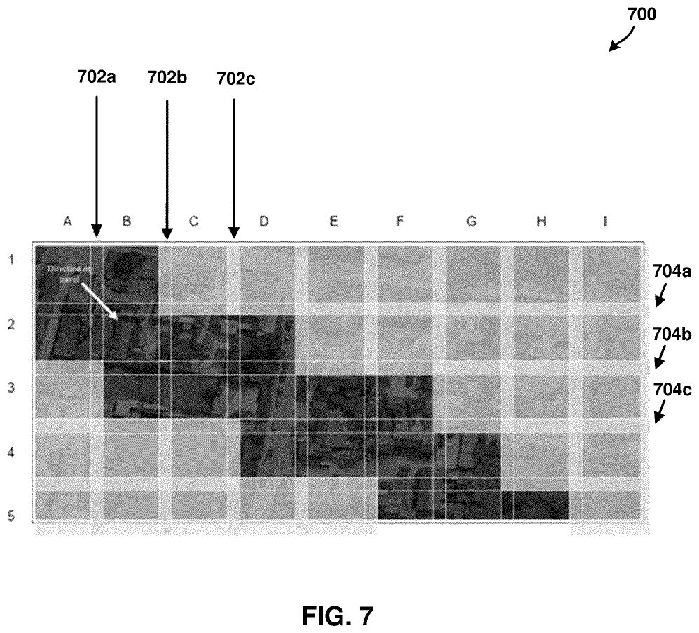

FIG. 7 illustrates map images 700 that have been divided into tiles in accordance with some embodiments. The processing system may retrieve the map images and divide them into tiles that correspond to segments of the aerial vehicle's route. The processing system may define the tiles along a grid and assign them to route segments spanning from tile A1 to tile G5. The processing system may configure adjacent tiles to overlap to maintain continuity along the route. The tiles in column A have an overlap 702a with the tiles in column B, the tiles in column B may have an overlap 702b with the tiles in column C, etc. Similarly, the tiles in row 1 may overlap 704a with the tiles in row 2, and the tiles in row 2 may overlap 704b with the tiles in row 3. The overlap may prevent data gaps and improve positional accuracy when the aerial vehicle transitions between tiles.

The processing system may manage the overlap to reduce errors at tile boundaries. The processing system may adjust the overlap based on route complexity and terrain conditions to improve navigation accuracy. If the route includes dense urban areas or rugged terrain, the processing system may increase the overlap to retain redundant data and improve alignment between adjacent tiles. If the route passes through open landscapes with little terrain variation, the processing system may reduce the overlap to improve storage efficiency. The processing system may also apply predefined thresholds to maintain an acceptable margin of error during transitions between tiles.

The processing system may include additional tiles along the route to account for terrain variability or environmental conditions. The processing system may dynamically adjust tile placement to support navigation accuracy as the aerial vehicle moves along the route. The processing system may continuously monitor the route and modify the tile configuration in response to changing conditions. These adjustments may allow the aerial vehicle to maintain stable localization and avoid navigation errors caused by inconsistent map data.

Returning to FIG. 5A, the processing system may determine the tile size in block 510 based on the processing power and storage capacity of the NASR compute and sensor module in the aerial vehicle. The processing system may allocate larger tiles when the module has sufficient processing power and memory to reduce the number of tile transitions. If the module has lower processing power or limited available memory, or if the system must handle additional concurrent tasks, the processing system may define smaller tiles to decrease computational load.

The processing system may adjust tile size dynamically based on pre-mission diagnostics and available storage capacity. If storage is limited, the processing system may reduce tile overlap while maintaining feature alignment along the route. The processing system may increase tile overlap in response to terrain complexity, particularly in regions with dense obstacles such as forests or urban environments. If the aerial vehicle moves at high speed relative to the surface, the processing system may allocate additional overlap to compensate for motion blur and prevent positional drift. If the environment lacks distinguishing features, the processing system may reduce overlap to optimize storage efficiency.

In block 512 illustrated in FIG. 5A, the processing system may perform the operations in blocks 514-538 illustrated in FIG. 5B to generate tile features. For example, the processing system may analyze each tile to extract relevant visual or spatial characteristics that may assist the NASR compute and sensor module in performing real-time localization during flight. The processing system may apply feature detection algorithms (e.g., keypoint extraction, template matching, etc.) to generate a structured dataset of tile features that align with the aerial vehicle's operational pipeline.

In some embodiments, as part of the operations in block 512, the processing system may extract features from each tile and store them in a route features data structure. The processing system may optimize storage by applying dimensionality reduction techniques, including principal component analysis and wavelet-based compression. The processing system may eliminate redundant keypoints by clustering similar features and prioritizing those with the highest stability. If the processing system processes a region with dense urban infrastructure, it may retain distinctive features (e.g., building edges, road intersections, etc.) while discarding repetitive patterns (e.g., evenly spaced windows, etc.). In rural environments, the processing system may prioritize natural landmarks (e.g., tree clusters, river bends, elevation changes, etc.) that provide stable reference points for localization. The processing system may assign confidence scores to each extracted feature based on its stability under geometric transformations and variations in viewing angles.

With reference to FIG. 5B, in block 514, the processing system may determine the pipeline used by the aerial vehicle. The pipeline selection may depend on the aerial vehicle details received in block 504. If the aerial vehicle operates with a vision-based navigation system, the processing system may assign a keypoint-based pipeline that extracts and indexes distinguishable features from each tile, such as edges, corners, or unique textures. If the aerial vehicle relies on template-based matching for localization, the processing system may assign a pipeline that generates reference templates by segmenting the tiles into predefined patterns optimized for correlation-based comparison.

In some embodiments, the processing system may retrieve the aerial vehicle specifications from a repository based on the make and model provided in block 504. For example, a fixed-wing aerial vehicle designed for long-range surveillance may require a pipeline configured for high-altitude feature recognition. On the other hand, a quadrotor drone performing low-altitude inspections may use a pipeline configured for ground-level structures and terrain details.

In some embodiments, the processing system may select a hybrid pipeline that combines multiple feature extraction techniques based on the operating environment. For example, if the mission requires the aerial vehicle to transition between urban and rural environments, the processing system may apply a keypoint-based pipeline in urban areas where distinct building structures provide reliable reference points and a template-based pipeline in rural areas where natural terrain features may lack distinct keypoints. The processing system may store the selected pipeline configuration in a mission parameter file that is deployed to the aerial vehicle before takeoff.

In determination block 516, the processing system may determine whether a keypoint-based pipeline should be used. The processing system may evaluate the mission parameters, aerial vehicle specifications, and environmental conditions to make this determination. For example, if the aerial vehicle is equipped with a vision-based navigation system that relies on feature matching, the processing system may select a keypoint-based pipeline. The processing system may also select this pipeline if the aerial vehicle is expected to operate in urban environments where buildings, road intersections, and other man-made structures provide a high density of identifiable keypoints.

In some embodiments, the processing system may analyze the map images retrieved in block 508 to assess the feasibility of using a keypoint-based pipeline. For example, the processing system may determine that a keypoint-based pipeline is suitable in response to determining that the images include a sufficient number of distinct features (e.g., high-contrast edges, textured surfaces, unique geometrical patterns, etc.). The processing system may select an alternative pipeline in response to determining that the images primarily depict featureless terrain (e.g., open water, deserts, uniform snowfields, etc.).

In response to determining that a keypoint-based pipeline should be used (i.e., determination block 516=“Yes”), the processing system may determine whether there is an unprocessed tile in determination block 518. The processing system may maintain a list or queue of tiles that require feature extraction and may sequentially or concurrently process the tiles based on available computing resources.

In response to determining that there is an unprocessed tile (i.e., determination block 518=“Yes”), the processing system may generate tile features using a keypoint-based pipeline in block 520. The processing system may apply feature detection algorithms, such as the Scale-Invariant Feature Transform (SIFT), Speeded-Up Robust Features (SURF), or Oriented FAST and Rotated BRIEF (ORB), to extract and describe keypoints from the tile. These keypoints may include corners, edges, or other unique visual markers that the NASR compute and sensor module may match against sensor data captured by the aerial vehicle during flight.

For example, the processing system may process a satellite image tile of an urban area and detect keypoints at intersections, building corners, or signage locations. Each detected keypoint may be assigned a descriptor encoding its orientation, scale, and intensity pattern, allowing the NASR compute and sensor module to match the keypoints against real-time camera images captured during the mission.

In some embodiments, the processing system may enhance keypoint detection by applying contrast normalization, edge enhancement, or multi-scale analysis. For example, the processing system may apply histogram equalization to improve keypoint detectability in response to determining that the retrieved satellite image tile exhibits low contrast due to atmospheric haze. The extracted keypoints and descriptors may be stored in a structured format within the route features data structure for subsequent deployment to the aerial vehicle.

In block 522, the processing system may add the extracted tile features to a route features data structure that includes tile features for every tile that forms part of a route. The route features data structure may organize the extracted keypoints and descriptors in a structured format that the NASR compute and sensor module may access during the mission. The processing system may store each tile's feature set along with its geographic coordinates so that each feature is accurately associated with its corresponding spatial location.

For example, if a tile includes an urban environment with multiple keypoints detected at building edges, road intersections, or signage locations, the processing system may store these keypoints along with their feature descriptors, image coordinates, and associated metadata, including scale, orientation, and contrast levels. The processing system may assign confidence scores to each keypoint based on its stability under transformations so that features with higher reliability are prioritized during in-flight matching. In rural environments, the processing system may prioritize stable natural landmarks, such as tree clusters, river bends, or elevation changes that provide reliable reference points.

In some embodiments, the processing system may improve the storage of tile features by applying data compression techniques, such as principal component analysis (PCA) or feature selection algorithms, to retain relevant features while reducing memory requirements. The processing system may also cluster similar keypoints within a tile to eliminate redundant data and improve retrieval efficiency. If the processing system detects repeated keypoints from overlapping tiles, it may group them together, removing duplicates to optimize storage and improve access speed.

In response to determining that a keypoint-based pipeline should not be used (i.e., determination block 516=“No”), the processing system may determine whether a template-based pipeline should be used in block 524. The processing system may analyze the map images and mission parameters to evaluate whether template matching is suitable for feature extraction. For example, if the terrain includes repetitive or uniform features (e.g., agricultural fields, large bodies of water, etc.) the processing system may determine that a template-based pipeline offers better consistency for feature extraction. On the other hand, the processing system may determine that a keypoint-based pipeline should be used in response to determining that the terrain includes a urban environment in which distinctive features such as building corners and road intersections are common.

In some embodiments, the processing system may analyze the aerial vehicle's expected altitude and camera resolution to determine the feasibility of template-based matching. If the expected altitude results in a ground sample distance (GSD) that maintains sufficient detail for template matching, the processing system may proceed with selecting this pipeline. For example, at a high altitude, the aerial vehicle may capture a broad area with fewer distinct visual features. In such cases, template matching may provide more consistent results than keypoint detection.

In response to determining that a template-based pipeline should be used (i.e., determination block 524=“Yes”), the processing system may determine whether there is an unprocessed tile in determination block 526. The processing system may maintain a queue of unprocessed tiles and process them sequentially or in parallel based on available computing resources. For example, if the route spans a large area, the processing system may process tiles in parallel to reduce overall computation time, particularly in regions with uniform terrain where template matching provides higher efficiency.

In some embodiments, the processing system may prioritize unprocessed tiles based on mission parameters, such as processing high-priority regions first. If the mission requires precise navigation in areas with increased operational risk (e.g., airspace congestion, proximity to infrastructure, etc.) the processing system may process tiles in those regions first. In contrast, tiles corresponding to lower-priority areas, such as open fields, may be associated with a lower priority.

In response to determining that there is an unprocessed tile (i.e., determination block 526=“Yes”), the processing system may generate tile features using a template-based pipeline in block 528. The processing system may select representative templates from the tile and match them against expected sensor inputs during the mission. For example, if the aerial vehicle is expected to fly over a suburban environment, the processing system may extract templates representing common features such as intersections, rooftops, or road markings. These templates may be stored with associated scale and rotation parameters, allowing the NASR compute and sensor module to match real-time sensor data against stored templates during flight.

In some embodiments, the processing system may apply preprocessing techniques, such as edge detection or histogram equalization, to enhance template recognition. If the map images include low-contrast areas, the processing system may adjust the brightness and contrast levels before extracting templates. If the images of a rural area appear dim due to environmental conditions such as haze or low light, the processing system may apply contrast enhancement techniques to improve feature visibility. The extracted templates and associated metadata may then be added to the route features data structure to allow the aerial vehicle to reference them in real-time for localization and navigation.

In block 530, the processing system may add the tile features to a route features data structure that includes tile features for every tile that forms part of a route. The processing system may associate each tile feature with its corresponding geographic coordinates to maintain accurate mapping between extracted features and real-world locations. The processing system may store tile features in a structured format optimized for retrieval by the NASR compute and sensor module during flight.

For example, if a tile corresponds to a complex urban area, the processing system may store features representing intersections, building corners, or other identifiable landmarks to support real-time matching. If a tile includes a highway intersection, the processing system may extract lane markings, overpasses, and road edges as feature descriptors and store them along with their geographic locations in the route features data structure. Each feature may include metadata such as orientation, scale, and contrast levels to improve real-time matching against sensor data collected by the aerial vehicle. If the route includes regions with repetitive patterns (e.g., agricultural fields, structured urban grids, etc.) the processing system may apply feature refinement techniques to prioritize distinct and stable features that improve localization accuracy. In rural environments, the processing system may prioritize natural features such as ridgelines or water bodies that provide stable reference points for navigation.

In some embodiments, the processing system may apply compression techniques to reduce storage requirements. The processing system may cluster similar features within a tile to eliminate redundant data while preserving high-value keypoints for localization. If multiple tiles share common feature sets due to overlapping regions, the processing system may reference previously stored features instead of duplicating data, improving storage efficiency. If several tiles contain similar building structures or terrain features, the processing system may avoid redundancy by referencing a common set of stored features.

In some embodiments, the processing system may organize the route features data structure using a hierarchical indexing system. For example, the processing system may group tile features based on proximity to waypoints or mission-critical locations. If the aerial vehicle is expected to navigate through complex environments (e.g., a canyon, a dense urban corridor, etc.), the processing system may assign higher retrieval priority to tile features in those areas to ensure rapid access during flight operations. This prioritization may support real-time processing performance in navigation scenarios that require high precision.

In response to storing the tile features, the processing system may verify data integrity by computing checksums or validating feature consistency across adjacent tiles. If discrepancies exist between overlapping tiles, the processing system may refine feature alignment by adjusting georeferencing parameters. These refinements may allow the NASR compute and sensor module to receive accurate route feature data and improve navigation reliability. If two overlapping tiles show inconsistencies in feature locations due to slight misalignment, the processing system may adjust the coordinates and realign the features to ensure accurate navigation during the mission.

In some embodiments, as part of the operations in block 530, the processing system may validate stored features by performing integrity checks across overlapping tiles. The processing system may compute checksums for extracted features to detect data corruption. The processing system may compare overlapping regions between adjacent tiles and resolve inconsistencies by refining feature alignment. If the processing system detects a discrepancy between two overlapping tiles, it may adjust georeferencing parameters or reprocess the affected area to improve consistency. If the processing system previously stored features from a region in a prior mission, it may compare newly extracted features with historical data to detect environmental changes. If a previously processed tile includes new infrastructure, the processing system may detect the change and update the feature set accordingly.

In response to determining that a template-based pipeline should not be used (i.e., determination block 524=“No”), the processing system may determine whether another type of pipeline should be used in block 532. The processing system may select an alternative pipeline based on mission parameters, environmental conditions, or the aerial vehicle's capabilities. The alternative pipeline may include deep-learning-based feature extraction, terrain-matching techniques, or spectral analysis.

For example, the processing system may select a deep-learning-based pipeline designed to process infrared imagery rather than visible-light images in response to determining that the aerial vehicle is operating in a low-visibility environment (e.g., in fog, at night, etc.). As further examples, the processing system may select a terrain-matching pipeline that relies on elevation maps or LiDAR scans to define features in response to determining that the aerial vehicle is operating in a desert environment in which traditional keypoint-based and template-based approaches do not perform well (e.g., due to a lack of distinct landmarks, etc.). Terrain-matching may be particularly effective in forested or mountainous regions because it uses height data to identify prominent features such as ridges or valleys.

In response to determining that another type of pipeline should be used (i.e., determination block 532=“Yes”), the processing system may determine whether there is an unprocessed tile in determination block 534. The processing system may maintain a queue of unprocessed tiles and select the next available tile for processing. The processing system may also prioritize tiles based on mission parameters, such as proximity to waypoints or areas where precise navigation is required. For example, if the aerial vehicle is assigned to inspect a high-priority target, such as critical infrastructure or a hazard zone, the processing system may prioritize processing tiles that cover these areas or the others. As further examples, if the aerial vehicle is surveying a coastline, the processing system may prioritize tiles covering water-to-land transition zones where frequent navigation adjustments may be required. If the mission involves inspecting infrastructure such as power lines or roads, the processing system may prioritize tiles including structures of interest and defer processing of surrounding terrain that is less relevant.

In response to determining that there is an unprocessed tile (i.e., determination block 534=“Yes”), the processing system may generate tile features using another type of pipeline in block 536. The processing system may extract features using the selected alternative method and encode them for efficient retrieval by the NASR compute and sensor module. The extracted features may include edge contours, surface textures, elevation gradients, or spectral signatures depending on the type of pipeline selected. For example, if a deep-learning-based pipeline is selected, the processing system may use a neural network model to analyze satellite imagery and extract features representing buildings, roads, and vegetation. The processing system may encode these detected features as vectorized data points for rapid retrieval. If a spectral analysis pipeline is selected, the processing system may analyze multispectral or hyperspectral imagery to detect material properties (e.g., soil type, vegetation density, etc.) that support localization.

In block 538, the processing system may add the tile features to a route features data structure that includes tile features for every tile that forms part of a route. The processing system may store each feature with associated metadata, including geographic coordinates, confidence scores, and processing timestamps. If the features were generated using an AI-based model, the processing system may include additional metadata such as classification probabilities or uncertainty estimates. For example, if a deep-learning-based model processes a tile, the processing system may assign a confidence score to the extracted features based on the model's classification probability. As further examples, if the aerial vehicle navigates a glacier, the processing system may label ice formations with confidence scores derived from historical data and sensor readings. If the mission involves urban navigation, the processing system may classify buildings based on their height and orientation to improve feature matching. The processing system may perform validation checks on newly generated features by comparing them with previously processed tiles or external reference data to improve accuracy.

In response to adding the features to the route features data structure, the processing system may update its tile processing queue, marking the tile as processed and selecting the next unprocessed tile. The processing system may repeat the feature extraction and storage operations until all required tiles for the route are processed.

In response to determining that another type of pipeline should not be used (i.e., determination block 532=“No”), the processing system may create an empty route features data structure. The processing system may allocate memory for the data structure but leave it unpopulated due to the absence of processed tile features. Without route features, the NASR compute and sensor module (e.g., NASR compute and sensor module 300 with reference to FIG. 3A) may be unable to assist the aerial vehicle in pose determination during the mission (e.g., as part of operation 420 with reference to FIG. 4).

For example, if the aerial vehicle is tasked with navigating a predefined route and the processing system does not generate route features due to missing or incompatible pipeline configurations, the NASR compute and sensor module may lack feature references for localization. As a result, the aerial vehicle may rely on GNSS and IMU data without additional environmental feature matching. The processing system may generate a diagnostic report indicating the absence of route features. This may prompt an operator to review and adjust the pipeline selection before deployment.

In response to determining that there is not an unprocessed tile (i.e., determination block 518=“No,” determination block 526=“No,” or determination block 534=“No”), the processing system may deploy the mission parameters to the aerial vehicle in block 540. The mission parameters may include the calculated route, route features, threshold score, and coordinate mapping function. The processing system may transmit the mission parameters over a wired or wireless communication link, such as a secure radio frequency (RF) channel, an encrypted data link, or a cloud-based synchronization system. For example, in a real-time mission planning scenario, the processing system may package the mission parameters into a structured data format (e.g., JSON, etc.) and transmit them to the aerial vehicle's onboard flight computer. If the aerial vehicle operates in a disconnected environment, the processing system may store the mission parameters on a removable storage device (e.g., an SD card or USB drive) that an operator may insert into the aerial vehicle before takeoff.

Deploying route features instead of full-resolution map tiles may reduce storage and processing requirements on the aerial vehicle. Instead of storing large satellite image tiles, the aerial vehicle may retain compact feature representations that improve localization efficiency.

For example, if the aerial vehicle is performing an extended-range mission with limited onboard storage, the processing system may optimize route features for compactness by encoding keypoint descriptors or template matching parameters instead of the entire image tiles. If the aerial vehicle relies on edge computing resources with constrained processing power, the processing system may prioritize low-complexity features that require minimal computation while maintaining navigation accuracy.

In some embodiments, the processing system may perform a verification step before deployment so that the route features align with the calculated trajectory and that the aerial vehicle has sufficient resources to process the deployed data. If any inconsistencies arise, the processing system may alert an operator to review and modify the mission configuration before the aerial vehicle departs.

In some embodiments, in block 540, the processing system may generate a final mission dataset that includes the calculated route, extracted features, and coordinate mapping functions. The processing system may deploy the mission dataset to the aerial vehicle over a secure communication channel or store it in a removable storage device for manual transfer. The processing system may reduce storage requirements by transmitting extracted features instead of full-resolution map images. The processing system may verify the integrity of the deployed mission dataset by confirming that stored features align with the planned trajectory and that the aerial vehicle has sufficient resources to process the data. If the processing system detects an inconsistency, it may generate an alert for an operator to review and adjust the mission parameters before deployment. The processing system may complete the mission preparation process by logging mission data, releasing processing resources, and preparing for execution.

The processing system may exit, end, terminate, or finish in block 542. The processing system may release allocated resources, close active data structures, and signal the completion of the mission preparation process. If the processing system is executing within a larger ground control system, it may log the mission parameters, pipeline selection, and route features before termination. The processing system may also generate a summary report including relevant details about the pre-flight processing, such as the number of tiles processed, the selected pipeline type, and any detected anomalies in the data.

In some embodiments, the processing system may perform the operations described with reference to blocks 510, 518-522, 526-530, and 534-538 before the mission to reduce processing time and resource consumption during mission preparation. In some embodiments, the processing system may execute multiple instances of blocks 520, 528, and 536 in parallel for different map tiles to improve processing efficiency.

In some embodiments, the processing system may use only one type of pipeline. If a single pipeline meets the mission requirements, some of blocks 514-538 may be optional. The processing system may determine whether multiple pipeline types are necessary based on the aerial vehicle's sensor configuration, computational resources, or environmental conditions. For example, the processing system may determine that a keypoint-based pipeline is the sole viable option in response to determining that the aerial vehicle includes an onboard computer/camera that supports only keypoint-based feature extraction. The processing system may bypass blocks related to template-based or other pipelines to reduce processing complexity and computational overhead. As another example, if the aerial vehicle's mission involves terrain that lacks distinct landmarks, the processing system may select a template-based pipeline instead of a keypoint-based approach so that feature generation aligns with environmental conditions. The processing system may forgo performing unnecessary pipeline selection steps to accelerate mission preparation while maintaining accuracy.

In some embodiments, the processing system may determine whether the pipeline selection process should bypass unnecessary computations. If the aerial vehicle requires a single feature extraction pipeline, the processing system may eliminate redundant processing blocks and streamline data preparation. The processing system may determine whether an alternative pipeline should be used by evaluating the operational environment. If the processing system determines that a keypoint-based pipeline does not provide sufficient reliability, it may select a template-based pipeline or a deep-learning-based pipeline to improve accuracy. The processing system may determine whether terrain-matching techniques provide a more reliable method for navigation by analyzing the consistency of extracted features.

In some embodiments, the processing system may execute multiple instances of some blocks in parallel across different tiles. Specifically, blocks 520, 528, and 536 may be executed concurrently so that the processing system may process multiple tiles simultaneously. The processing system may implement multithreading, multiprocessing, or distributed computing techniques to increase processing speed. For example, if the aerial vehicle's mission spans a large geographic area with hundreds of tiles, the processing system may assign different tile sets to separate processing threads or processors. A multicore processor may handle multiple tile processing tasks simultaneously, reducing the overall time required to generate route features. As another example, if the processing system operates within a cloud-based infrastructure, it may distribute tile processing workloads across multiple computing nodes, leveraging parallel execution to expedite mission preparation. The processing system may dynamically allocate computational resources based on workload intensity to improve efficiency while avoiding excessive resource consumption.

In some embodiments, the processing system may execute some blocks only once as part of ground control initialization, independent of any specific mission. The processing system may precompute and store relevant data, reducing the computational load, time requirements, and costs associated with preparing an aerial vehicle for flight. For example, the processing system may generate and cache common map tiles for frequently used flight corridors before any specific mission request. When an operator later defines a mission route within a preprocessed area, the processing system may retrieve precomputed tiles rather than generating them from scratch. This may reduce latency and improve system responsiveness. As another example, if the processing system processes tile features for a fleet of aerial vehicles operating in the same geographic region, it may perform tile chunking and feature extraction as part of a scheduled background task. This may reduce redundant processing by allowing multiple aerial vehicles to use the same precomputed route features.

In some embodiments, the processing system may implement a hybrid approach in which core processing operations, such as map retrieval and tile chunking, are executed once during initialization, while mission-specific operations, such as route calculation and tile feature extraction, are executed dynamically when a mission request is received. This may allow the aerial vehicle to rapidly deploy without excessive pre-flight delays.

In some embodiments, the processing system may execute tile processing operations (e.g., of blocks 520, 528, or 536) in parallel to improve efficiency. The processing system may allocate processing resources dynamically based on the complexity of each tile. The processing system may assign separate computing threads to tiles that include a high density of extracted features. The processing system may prioritize tiles that include terrain requiring high precision, including urban centers or areas with frequent elevation changes. If the processing system operates within a distributed computing environment, it may allocate tile processing workloads across multiple nodes and balance computational resources based on real-time system load.

FIG. 5C is a process flow diagram illustrating a method 560 of generating tile features using a keypoint-based pipeline in accordance with some embodiments (e.g., as part of block 520 with reference to FIG. 5B). Method 560 may be performed by a processor in the ground control (e.g., by ground control 104 with reference to FIG. 1).

In block 564, the processing system may detect keypoint locations in the tile. Keypoints may be locations within the map image of the tile (e.g., identified using pixel coordinates) that include recognizable features. The processing system may detect keypoints using feature detection algorithms (e.g., SIFT, SURF, ORB, etc.).

In determination block 566, the processing system may determine whether there is an unprocessed keypoint location. In response to determining that there is an unprocessed keypoint location (i.e., determination block 566=“Yes”), the processing system may create a descriptor for the keypoint location (e.g., identified using pixel coordinates) by generating a feature vector for the keypoint location in block 568. The descriptor may encode information such as orientation, scale, and intensity patterns. This descriptor may subsequently be used for matching the keypoint location (e.g., identified using pixel coordinates) for that keypoint to a location (e.g., identified using pixel coordinates) in another map image. A keypoint may include a keypoint location (e.g., identified using pixel coordinates) and a corresponding descriptor.

In block 570, the processing system may add the keypoint to a tile features data structure that includes all of the keypoints for a specific tile. The processing system may store the keypoint location, descriptor, and associated metadata in a structured format for retrieval by the NASR compute and sensor module during mission execution. The processing system may exit, end, terminate, or finish in block 572.

FIG. 5D is a process flow diagram illustrating a method 580 of generating tile features using a template-based pipeline in accordance with some embodiments (e.g., as part of block 528 with reference to FIG. 5B). Method 580 may be performed by a processor in the ground control (e.g., by ground control 104 with reference to FIG. 1).

In block 584, the processing system may generate a tensor for the tile by performing inference on tile (e.g., using a CNN). The neural network used to perform the inference may have been trained using any well-known trained model (e.g., using a publicly trained model such as COCO or ImageNet). The tensor may include a multi-dimensional data structure that includes multiple feature maps that maintain the spatial relations of the map image of the tile. The processing system may use this tensor representation to capture patterns relevant to template-based matching.

In block 586, the processing system may add the tensor to a tile features data structure. The processing system may store the tensor along with associated metadata, including geographic coordinates, scale, and feature extraction parameters, for retrieval by the NASR compute and sensor module during flight. The processing system may exit, end, terminate, or finish in block 588.

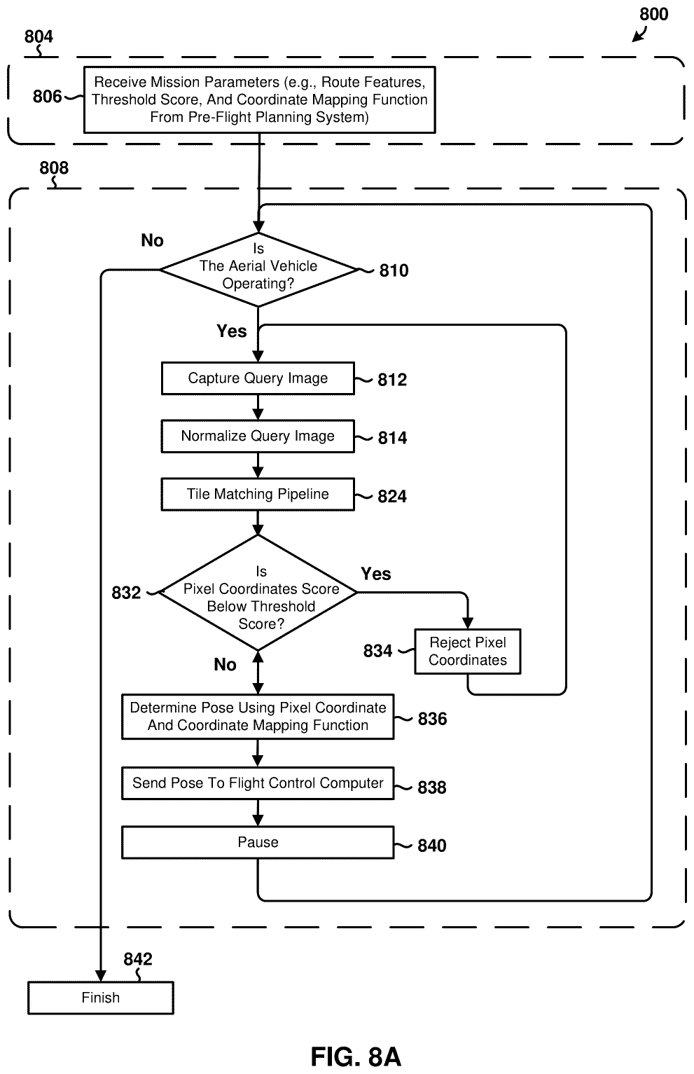

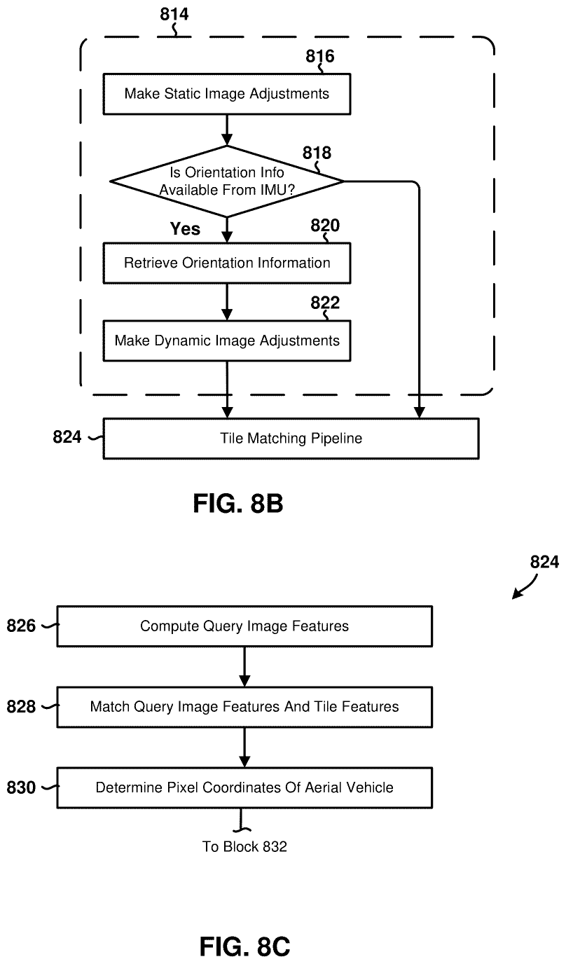

FIGS. 8A-8C are process flow diagrams illustrating a method 800 of generating a pose using a NASR compute and sensor module in an aerial vehicle in accordance with some embodiments. Method 800 may be performed by a processing system or processor in the NASR compute and sensor module (e.g., NASR compute and sensor module 300 with reference to FIG. 3A). Means for performing the functions of the operations in method 800 may include one or more processors, components or subsystems discussed in this application. One or more processors within the processing system may be configured with software or firmware to perform some or all of the operations of method 800.

With reference to FIG. 1-8C, in some embodiments, the processing system may perform the operations in block 804 before the aerial vehicle is in flight (e.g., as part of block 540 with reference to FIG. 5B). In some embodiments, the processing system may perform the operations in block 804 during flight if a mission update occurs and the aerial vehicle has an active data link to ground control (e.g., wireless connection 108 to ground control 104 with reference to FIG. 1).

In block 806, the processing system may receive (e.g., as part of block 540 with reference to FIG. 5B) mission parameters (e.g., route, route features, threshold score, and coordinate mapping function) from ground control (e.g., by a pre-flight planning system that is part of a ground control 104 with reference to FIG. 1). In some embodiments, one or more of these mission parameters may be embedded in the aerial vehicle, and thus the processing system may not need to receive them as part of block 804 or 806.

In some embodiments, the processing system may perform the operations in block 808 while the aerial vehicle is in flight.

In determination block 810, the processing system may determine whether the aerial vehicle is operating. In response to determining that the aerial vehicle is operating (i.e., determination block 810=“Yes”), the processing system may capture a query image (e.g., using one or more cameras 330 with reference to FIG. 3A) in block 812.

In block 814, the processing system may normalize the captured query image. Specifically, in block 816 illustrated in FIG. 8B, the processing system may make static image adjustments (e.g., adjust the exposure, adjust the focus, adjust the image temperature, adjust the noise, remove lens distortion).

In determination block 818, the processing system may determine whether orientation information is available from the IMU for the aerial vehicle (e.g., from IMU 324 with reference to FIG. 3A). In response to determining that orientation information is available from the IMU for the aerial vehicle (i.e., determination block 818=“Yes”), the processing system may retrieve the orientation information in block 820.

In block 822, the processing system may make dynamic image adjustments (e.g., rotating the image based on the aerial vehicle's orientation, resizing the image based on the aerial vehicle's altitude, ortho rectifying the image based on the aerial vehicle's pitch and/or roll).

In block 824, the processing system may invoke the tile matching pipeline that is used by the aerial vehicle. Specifically, in block 826 of FIG. 8C, the processing system may compute the query image features. In block 828, the processing system may match the query image features to the tile features in order to determine the best matching tile. In block 830, the processing system may determine the pixel coordinates of the aerial vehicle.

In the various embodiments, the specific details of blocks 824-830 may vary based on the pipeline that is being used by the aerial vehicle.

Returning to FIG. 8A, in determination block 832, the processing system may calculate a pixel coordinates score for the pixel coordinates of the aerial vehicle (or a confidence score for the determined pixel coordinates), and the processor may determine whether the pixel coordinates score is below a threshold score (i.e., the threshold score received in block 806). In response to determining that the pixel coordinates score is below a threshold score (i.e., determination block 832=“Yes”), the processing system may reject the pixel coordinates in block 834. Further, the processing system may then capture another query image and resume processing from block 812.

In response to determining that the pixel coordinates score is not below a threshold score (i.e., determination block 832=“No”), the processing system may determine a pose for the aerial vehicle using the pixel coordinates and a coordinate mapping function (i.e., the coordinate mapping function received in block 806) in block 836.

In some embodiments, the processing system may compute the pose by adding tile coordinate offsets to determine the aerial vehicle's pixel coordinates within the area of interest. The processing system may then apply the coordinate mapping function to translate the pixel coordinates into geographic coordinates.

In an alternative embodiment, a processor in the ground control (ground control 104 with reference to FIG. 1) may precompute a geographic transformation for each tile or calculate a geographic transform for every tile so that tile coordinate offsets do not need to be added. Thus, the processor in the aerial vehicle may then use the coordinate mapping function directly on the selected tile. That is, the processing system in the aerial vehicle may apply the coordinate mapping function directly to the selected tile without performing additional offset calculations.

In block 838, the processing system may send the pose to the flight control computer (e.g., flight control computer 332 with reference to FIG. 3A) in the aerial vehicle (e.g., as part of block 420 with reference to FIG. 4).

In block 840, the processing system may pause. The length of this pause may be related to the rate at which the camera is capable of capturing query images, the rate at which the NASR compute and sensor module can perform the pipelines, the speed of the aerial vehicle, and the size of the tiles.

In response to determining that the aerial vehicle is not operating (i.e., determination block 810=“No”), the processing system may exit, end, terminate, or finish in block 842.

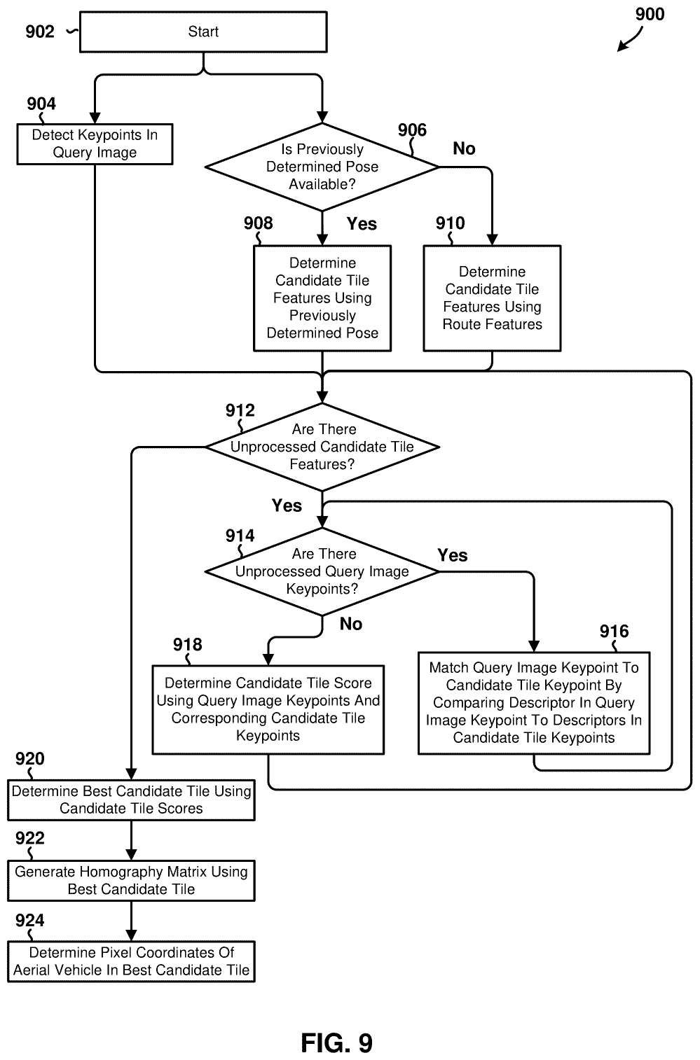

FIG. 9 is a process flow diagram illustrating a method of generating a pose using a keypoint-based pipeline in a NASR compute and sensor module in an aerial vehicle in accordance with some embodiments. Method 900 may be performed as part of blocks 824-830 with reference to FIGS. 8A-8C. Means for performing the functions of the operations in method 900 may include one or more processors, components or subsystems discussed in this application. One or more processors within the processing system may be configured with software or firmware to perform some or all of the operations of method 900.

With reference to FIGS. 1-9, in block 904, the processing system may compute the query image features by detecting keypoints in the query image. The processing system may extract keypoints from the query image using the same method described in method 560 with reference to FIG. 5C, substituting the query image for the tile. The process may start in block 902.

In determination block 906, the processing system may determine whether a previously determined pose for the aerial vehicle is available. In an enhanced embodiment, two or more previously determined poses may be used instead of a single pose.

In response to determining that a previously determined pose for the aerial vehicle is available (i.e., determination block 906=“Yes”), the processing system may determine the candidate tile features using the previously determined pose in block 908. The processing system may do this using any well known method (e.g., if the k nearest neighbors method is being used, and k=8, then the candidate tile features would include the tile features for the tile including the previously determined pose and the eight surrounding tiles).

In response to determining that a previously determined pose for the aerial vehicle is not available (i.e., determination block 906=“No”), the processing system may determine the candidate tile features using the route features in block 910.

Thus, the processing system may use the previously determined pose to select a subset of candidate tile features from the set of route features. That is, the availability of a previously determined pose may be used to select a proper subset of candidate tile features from the set of route features. In some embodiments, this reduction may dramatically reduce the search space, which in turn enables the pipeline to be executed significantly faster. Otherwise, the set of candidate tile features is equal to the set of route features, which effectively means that any search will be a brute force search.

Blocks 904-910 may be performed in series or in parallel.

In determination block 912, the processing system may determine whether there is an unprocessed candidate tile feature. In response to determining that there is an unprocessed candidate tile feature (i.e., determination block 912=“Yes”), the processing system may determine whether there is an unprocessed query image keypoint (i.e., a keypoint detected in operation 904) in determination block 914.

In response to determining that there is an unprocessed query image keypoint (i.e., determination block 914=“Yes”), the processing system may match the query image keypoint to a candidate tile keypoint in the candidate tile features by comparing the descriptor in the query image keypoint to each of the descriptors in the candidate tile keypoints in the candidate tile features in block 916. The processing system may select the candidate tile keypoint whose descriptor is closest to the descriptor in the query image keypoint. In an enhanced embodiment, the processing system may use any well known method to reduce the number of candidate tile keypoints to which it must make comparisons.

In response to determining that there is not an unprocessed query image keypoint (i.e., determination block 914=“No”), the processing system may determine the candidate tile score (i.e., the score for the candidate tile associated with the candidate tile features) using the query image keypoints and the corresponding candidate tile keypoints in operation 918. In some embodiments, the processing system may determine the candidate tile score by computing the average distance between the descriptors in the query image keypoints and the descriptors in the candidate tile keypoints. The processing system may use any well-known method for calculating the average distance (e.g., Euclidean, Mahalanobis).

The candidate tile score quantifies the similarity between the candidate tile and the query image using extracted keypoints and descriptors, without requiring access to the full image data of the candidate tile.

In an enhanced embodiment, the processing system may determine the candidate tile scores for two or more candidate tile features in parallel (i.e., blocks 914-918 may be performed in parallel on different candidate tile features).

In response to determining that there is not an unprocessed candidate tile feature (i.e., determination block 912=“No”), the processing system may determine the best candidate tile using the candidate tile scores in block 920 (e.g., if nine candidate tiles were processed as part of blocks 914-918, then the processing system may select the candidate tile with the lowest candidate tile score from the nine candidate tile scores). The best candidate tile corresponds to the tile with the highest degree of similarity to the query image based on the lowest computed candidate tile score.

In block 922, the processing system may generate a homography matrix (or an estimated homography matrix) using the best candidate tile. The homography matrix maps query image pixel locations to reference image pixel locations, while allowing for changes in the point-of-view. The processing system may use any well-known algorithm to generate the homography matrix (e.g., RANSAC). In some embodiments, the processing system may estimate a homography matrix using the keypoint matches between the query image and the best candidate tile. These may be the same matches that were made in block 916. In some embodiments, at least four matches may be required.

In block 924, the processing system may determine the pixel coordinates of the aerial vehicle in the best candidate tile by applying the homography matrix to the pixel coordinates of the centrepoint of the query image. Specifically, the processing system may determine the aerial vehicle's pixel location in the query image (i.e., the center of the query image, which is equivalent to the point directly below the aerial vehicle if it was not pitching and/or rolling). Said another way, the processing system may determine the aerial vehicle's pixel location in the query image as the center of the query image, which corresponds to the point directly beneath the aerial vehicle in the absence of pitch or roll. The processing system may then apply the homography matrix to this pixel location to retrieve the corresponding pixel location in the best candidate tile.

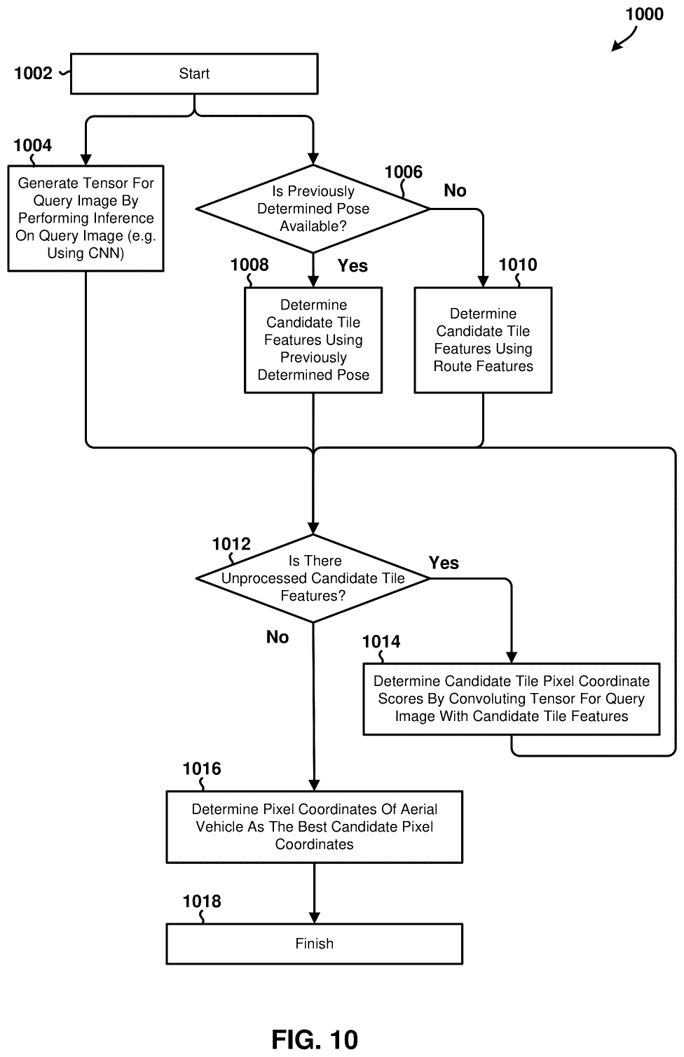

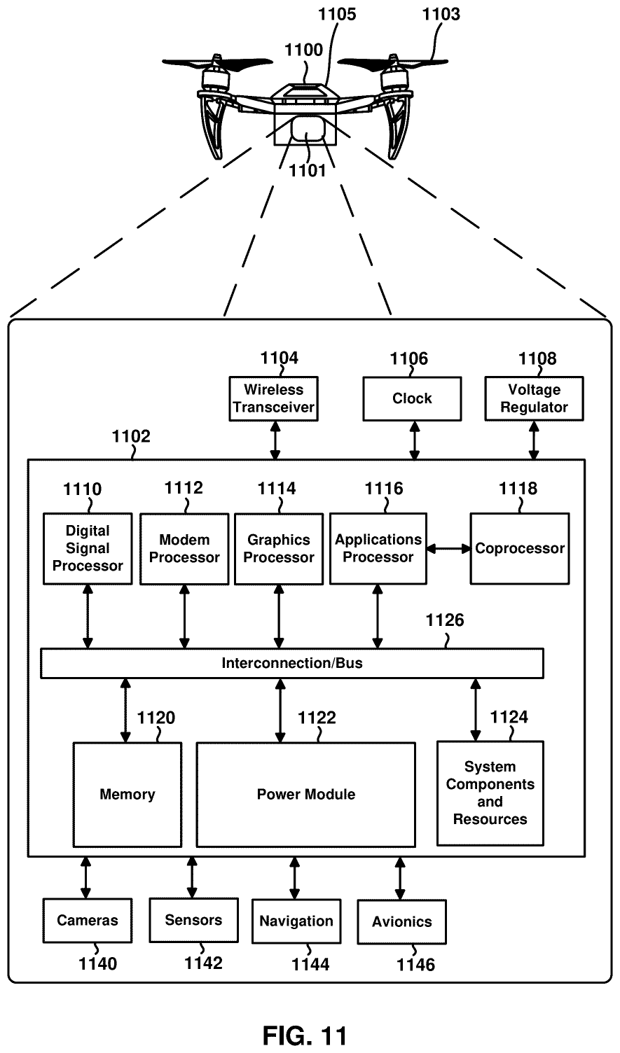

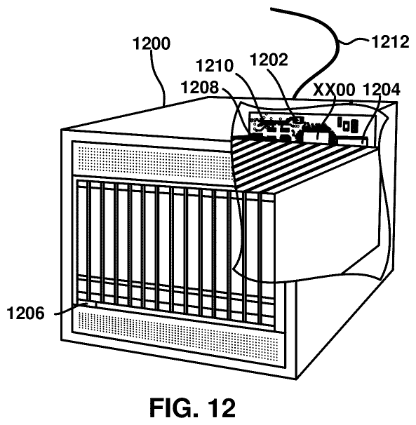

FIG. 10 is a process flow diagram illustrating a method of generating a pose using a template-based pipeline in a NASR compute and sensor module in an aerial vehicle in accordance with some embodiments. Method 1000 may be performed as part of blocks 824-830 with reference to FIG. 8. The process may start in block 1002.

With reference to FIGS. 1-10, in block 1004, the processing system may generate a tensor for the query image by performing inference on the query image (e.g., by using a CNN). The processor does this as described in method 580 with reference to FIG. 5D, with the query image used instead of the tile.

In determination block 1006, the processing system may determine whether a previously determined pose for the aerial vehicle is available. In response to determining that a previously determined pose for the aerial vehicle is available (i.e., determination block 1006=“Yes”), the processing system may determine the candidate tile features using the previously determined pose in block 1008. In response to determining that a previously determined pose for the aerial vehicle is not available (i.e., determination block 1006=“No”), the processing system may determine the candidate tile features using the route features in block 1010.

Blocks 1006-1010 are generally the same as blocks 906-910 with reference to FIG. 9, and they may be performed in series or in parallel.

In determination block 1012, the processing system may determine whether there is an unprocessed candidate tile feature. In response to determining that there is an unprocessed candidate tile feature (i.e., determination block 1012=“Yes”), the processing system may determine the candidate tile pixel coordinate scores by convoluting the tensor for the query image with the candidate tile feature tensor in block 1014. The output of block 1014 may be a two-dimensional probability map, where each pixel coordinate in the candidate tile is assigned a probability value indicating the likelihood of a match to the query image.

In an enhanced embodiment, the processing system may determine the candidate tile pixel coordinate scores for two or more candidate tiles in parallel (i.e., block 1014 may be performed in parallel on different candidate tiles). For example, the processing system may perform block 1014 in parallel across multiple candidate tiles to allow for the simultaneous evaluation of multiple regions.

In response to determining that there is not an unprocessed candidate tile feature (i.e., determination block 1012=“No”), the processing system may determine the pixel coordinates of the aerial vehicle as the best candidate pixel coordinates in block 1016. The processing system may do this using any well-known method. In some embodiments, the processing system may select the pixel coordinates that have the highest probability from all of the pixel coordinates for all of the candidate tiles. In another embodiment, the processing system may compute the average value for each candidate tile's probability map and select the pixel coordinate with the highest probability from the candidate tile with the highest average value.

In block 1018, the processing system may exit, end, terminate, or finish.

Some embodiments may include components and/or processing systems configured to provide navigational information to an aerial vehicle. In some embodiments, the methods may include initializing an onboard system in the aerial vehicle that includes a NASR component or module and at least one camera equipped with a CMOS sensor. The method may further include acquiring initial pose information of the aerial vehicle through a GNSS (the initial pose information including at least an initial position and orientation of the aerial vehicle), capturing by the at least one camera a sequence of images of the environment below the aerial vehicle during flight, and processing the captured images (e.g., by the NASR module, etc.) to identify distinctive route features from the environment. In some embodiments, the processing may include generating AVL-derived pose information based on the identified route features. In some embodiments, the AVL-derived pose information may include a position and an orientation of the aerial vehicle that is independent of the information received from GNSS.

In some embodiments, the method may further include comparing (by the NASR module) the AVL-derived pose information with the GNSS-derived pose information to identify discrepancies that are indicative of potential GNSS compromise, determining by the NASR module a reliability score for both the AVL-derived pose information and the GNSS-derived pose information based on the comparison (e.g., by evaluating external factors affecting the GNSS reliability, etc.), using the reliability score to select a primary source of navigational information from either the AVL-derived pose information or the GNSS-derived pose information for guiding the aerial vehicle, and adjusting, by the onboard system, the flight path of the aerial vehicle based on the selected primary source of navigational information. In some embodiments, the method may further include completing the flight mission, such as by using the selected primary source of navigational information to navigate the aerial vehicle to a predetermined destination or through a series of waypoints.

Some embodiments may include methods of determining the pose of an aerial vehicle using route features which may include receiving, from a pre-flight planning system, mission parameters, in which the mission parameters include a route, route features, and a coordinate mapping function, in which the route features include at least one tile feature, capturing, using an on-board camera, a query image, computing the query image features, determining the candidate tile features, matching the query image features to the candidate tile features, determining the pixel coordinates of the aerial vehicle in a candidate tile, determining pose of the aerial vehicle using the pixel coordinates and the coordinate mapping function, and sending the pose to the flight control computer of the aerial vehicle.

In some embodiments, receiving, from a pre-flight planning system, mission parameters may include receiving mission parameters including a threshold score, and determining the pixel coordinates of the aerial vehicle in a candidate tile may include determining a score for the pixel coordinates, and discarding the pixel coordinates in response to determining that the score may be less than the threshold score.

In some embodiments, capturing, using an on-board camera, a query image may include adjusting the exposure of the query image, In some embodiments, capturing, using an on-board camera, a query image may include adjusting the query image based upon the orientation of the aerial vehicle.

In some embodiments, computing the query image features may include detecting at least one keypoint in the query image, and creating a descriptor for the keypoint location, matching the query image features to the candidate tile features may include matching at least one query image keypoint to a candidate tile keypoint, determining a candidate tile score by computing at least one distance between a descriptor in the query image keypoint and a descriptor in the corresponding candidate tile keypoint, determining the best candidate tile using the candidate tile score, and determining the pixel coordinates of the aerial vehicle in a candidate tile may include generating a homography matrix using the best candidate tile, and applying the homography matrix to the pixel coordinates of the centrepoint of the query image.

In some embodiments, creating a descriptor for the keypoint location may include creating a feature vector for the pixel coordinates of the keypoint location.

In some embodiments, computing the query image features may include generating a tensor for the query image by performing inference on the query image using a CNN, matching the query image features to the candidate tile features may include convoluting the tensor with at least one candidate tile feature tensor, and determining the pixel coordinates of the aerial vehicle in a candidate tile may include determining the pixel coordinates of the aerial vehicle as the best candidate pixel coordinates from the convoluted tensor.

In some embodiments, determining the candidate tile features may include using a previous pose of the aerial vehicle to determining the candidate tile features.

Some embodiments may further include receiving, in a flight control computer of the aerial vehicle, the pose, creating a unified pose by combining the received pose with any other available poses, determining whether the unified pose may be correct for route, determining the route adjustment needed in response to determining that the unified pose may be not correct for route, and adjusting at least one of the thrust and the control surfaces for the aerial vehicle.

In some embodiments, chunking the images to create tiles may include chunking the images based on at least of one the aerial vehicle's processing power, the aerial vehicle's storage, and the distance of the route.

In some embodiments, generating tile features may include detecting at least one keypoint in a tile, creating a descriptor for the keypoint location, adding the keypoint location and the descriptor to the tile keypoints, and adding the tile keypoints to the tile features.

In some embodiments, generating tile features may include generating a tensor for a tile by performing inference on the tile using a CNN, and adding the tensor to the tile features.

In some embodiments, the mission requirements include an origin and a destination, calculating a route, retrieving tile features for the route, adding the tile features to a route features, and deploying, to an aerial vehicle, mission parameters, in which the mission parameters include the route, the route features, and a coordinate mapping function.

FIG. 11 is an illustration of an example aerial vehicle 1100 that is equipped with a computing system 1101 suitable for implementing some embodiments. In the example illustrated in FIG. 11, the aerial vehicle 1100 includes a structural frame 1105 and propulsion components such as rotors 1103. The frame 1105 may provide support for motors associated with the rotors 1103 or other propulsion systems. Certain structural and electrical details, such as wiring and frame interconnects, are omitted for clarity. The aerial vehicle 1100 may be a rotary-wing aircraft, a fixed-wing aircraft, an electric vertical takeoff and landing (eVTOL) aircraft, or a hybrid configuration that integrates multiple propulsion technologies. In addition, the aerial vehicle 1100 may include gas-electric hybrid propulsion, turbo-prop propulsion, or alternative power sources such as hydrogen fuel cells. Accordingly, nothing in the claims should be limited to propeller or rotor based aircraft unless expressly recited as such in the claims.

The aerial vehicle 1100 may include a computing system 1101 that executes navigation, control, and mission-specific operations. The computing system 1101 may be a system-in-a-package (SIP) that includes a system-on-chip (SOC) 1102, a wireless transceiver 1104, a clock 1106, a voltage regulator 1108, one or more cameras 1140, sensors 1142, navigation components 1144, and avionics components 1146. The SOC 1102 may integrate multiple processing units, such as a digital signal processor (DSP) 1110, a modem processor 1112, a graphics processing unit (GPU) 1114, an applications processor 1116, and a co-processor 1118. The SOC 1102 may execute flight management system (FMS) functions, automated flight control functions, and real-time navigation computations.

The processors 1110, 1112, 1114, 1116, and 1118 may communicate with memory elements 1120, a power module 1122, and system resources 1124 via an interconnection bus 1126. The interconnection bus 1126 may include a reconfigurable logic array, a high-performance network-on-chip (NoC), or a shared bus architecture. The computing system 1101 may include additional processing cores or specialized hardware accelerators configured for real-time image processing, sensor fusion, and AI-driven decision-making.

The SOC 1102 may function as a central processing unit (CPU) that executes software applications and performs arithmetic, logic, control, and input/output (I/O) operations. Each processor may include multiple cores that execute independent or parallelized operations. The SOC 1102 may support heterogeneous operating systems, where one processor executes a first type of operating system (e.g., FreeBSD, Linux) while another processor executes a different type (e.g., Windows).

The processors 1110, 1112, 1114, 1116, and 1118 may be part of a processing system that implements a multi-core, clustered architecture. A processor cluster may include multiple computing nodes, such as CPU cores, SOCs, or SIPs, that operate in coordination to execute computational tasks. Each node may execute an independent instance of an operating system and include dedicated memory and storage. Distributed computing tasks may be assigned to multiple nodes, allowing computational workloads to be executed in parallel. CPU cluster architectures may improve processing speed and fault tolerance by allowing for computational redundancy across multiple nodes.

The SOC 1102 may integrate additional system components and resources to manage sensor data, perform analog-to-digital conversions, and support high-speed data transmission. These components may include power amplifiers, voltage regulators, oscillators, phase-locked loops, peripheral interfaces, and memory controllers. The computing system 1101 may communicate with peripheral devices, including cameras 1140, display interfaces, wireless transceivers, and storage systems.

The power module 1122 may provide energy to the aerial vehicle 1100, including processors 1110, 1112, 1114, 1116, and 1118, as well as cameras 1140 and sensors 1142. The power module 1122 may include rechargeable battery cells, capacitors, or energy storage components designed for extended flight operations. The computing system 1101 may include energy management circuits that regulate power distribution and monitor energy consumption.

The aerial vehicle 1100 may include one or more cameras 1140 that capture images or video. The cameras 1140 may be optical sensors that detect visible light, infrared radiation, ultraviolet light, or other electromagnetic spectra. The sensors 1142 may include inertial measurement units (IMUs), accelerometers, gyroscopes, magnetometers, barometers, airspeed sensors, and temperature sensors. Additional sensors may include radar, lidar, sonar, time-of-flight (ToF) cameras, and radio frequency (RF) sensors. The sensor data may be used for real-time navigation, obstacle detection, environmental monitoring, and AVL computations.

The navigation unit 1144 may include a planning system that determines flight paths based on mission objectives, environmental data, and operational constraints. The navigation unit 1144 may receive input from the avionics components 1146 and may incorporate AI-driven algorithms for real-time decision-making. The avionics components 1146 may process altitude, attitude, airspeed, and heading data to support autonomous flight operations. The aerial vehicle 1100 may use dead reckoning between GNSS updates or operate without GNSS using sensor-based pose estimation methods.

The SOC 1102 may include additional input/output interfaces to communicate with external resources, such as the wireless transceiver 1104, clock 1106, and voltage regulator 1108. The wireless transceiver 1104 may support multiple communication protocols, including 5G, satellite communication, and ultra-wideband (UWB) links. The aerial vehicle 1100 may establish real-time communication with a ground control station or other aerial vehicles.

The computing system 1101 may be configured to process real-time sensor data, execute AI-driven flight optimizations, and support secure, autonomous flight operations in environments in which traditional GNSS-based navigation may be unreliable or unavailable.

In addition to the example SIP or computing system 1101 discussed above, various embodiments may be implemented in a wide variety of computing systems, which may include a single processor, multiple processors, multicore processors, or any combination thereof.

All or portions of some embodiments may be implemented in the cloud or on a variety of commercially available computing devices, such as the server computing device 1200 illustrated in FIG. 12. The server device 1200 may include a SoC or one or more processors 1202 (e.g., multi-core processor, etc.) coupled to memory 1204, storage interfaces 1206 such as USB ports and NVMe slots, and network access ports 1208 that allow data connections through a network interface card (NIC) 1210 and a communication network 1212 (e.g., an Internet Protocol (IP) network) connected to other network elements.

For the sake of clarity and ease of presentation, the methods discussed in this application are presented as separate embodiments. While each method is delineated for illustrative purposes, it should be clear to those skilled in the art that various combinations or omissions of these methods, blocks, operations, etc. could be used to achieve a desired result or a specific outcome. It should also be understood that the descriptions herein do not preclude the integration or adaptation of different embodiments of the methods, blocks, operations, etc. from producing a modified or alternative result or solution. The presentation of individual methods, blocks, operations, etc. should not be interpreted as mutually exclusive, limiting, or as being required unless expressly recited as such in the claims.

The processors discussed in this application may be any programmable microprocessor, microcomputer, or a combination of multiple processor chips configured by software instructions (applications) to perform diverse functions, including those of the various embodiments described herein. Severs often include multiple processors, with dedicated processors for specific tasks such as managing cloud computing operations, data analytics, or wireless communication functions. Software applications may be stored in the internal memory before being accessed and executed by the processor. Modern processors may include extensive internal memory, often augmented with fast access cache memory, to efficiently store and process application software instructions.

Implementation examples are described in the following paragraphs. While some of the following implementation examples are described in terms of example methods, further example implementations may include: the example methods discussed in the following paragraphs implemented by a computing device including processing system coupled to memory and configured (e.g., with processor-executable instructions) to perform operations of the methods of the following implementation examples; the example methods discussed in the following paragraphs implemented by a computing device including means for performing functions of the methods of the following implementation examples; and the example methods discussed in the following paragraphs may be implemented as a non-transitory processor-readable storage medium having stored thereon processor-executable instructions configured to cause a processor of a computing device to perform the operations of the methods of the following implementation examples.

Example 1: A method of determining the pose of an aerial vehicle using route features, the method including receiving, at a processing system of the aerial vehicle, mission parameters from a pre-flight planning system, the mission parameters including a route, route features, and a coordinate mapping function, in which the route features include at least one tile feature, capturing, using an on-board image sensor of the aerial vehicle, a query image of an area corresponding to the route, computing, by the processing system, query image features from the query image, determining, by the processing system, candidate tile features from the route features based on the mission parameters, matching, by the processing system, the query image features to the candidate tile features to identify a matching tile, determining, by the processing system, pixel coordinates of the aerial vehicle within the matching tile, determining, by the processing system, a pose of the aerial vehicle using the pixel coordinates and the coordinate mapping function, and sending the determined pose to a flight control computer of the aerial vehicle.

Example 2: The method of example 1, in which receiving the mission parameters includes receiving a threshold score associated with pixel coordinate accuracy, and determining the pixel coordinates of the aerial vehicle includes calculating a confidence score for the pixel coordinates, and discarding the pixel coordinates in response to determining that the confidence score is below the threshold score.

Example 3: The method of any of examples 1 and 2, in which capturing the query image includes adjusting the exposure of the query image based on ambient lighting conditions.

Example 4: The method of any of examples 1-3, in which capturing the query image includes adjusting the query image based on orientation data obtained from an inertial measurement unit (IMU) of the aerial vehicle.

Example 5: The method of any of examples 1-4, in which computing the query image features includes detecting at least one keypoint in the query image, and generating a descriptor for each detected keypoint,

Example 6: The method of any of examples 1-5, in which matching the query image features to the candidate tile features includes selecting at least one candidate tile keypoint corresponding to a detected query image keypoint, determining a candidate tile score by computing a distance metric between a descriptor of the query image keypoint and a descriptor of the candidate tile keypoint, and selecting a best candidate tile based on the candidate tile score

Example 7: The method of any of examples 1-6, in which determining the pixel coordinates of the aerial vehicle includes generating a homography matrix based on the best candidate tile, and applying the homography matrix to the pixel coordinates of a central region of the query image.

Example 8: The method of any of examples 1-7, in which generating the descriptor for each detected keypoint includes generating a feature vector representing spatial relationships of pixel coordinates relative to the keypoint.

Example 9: The method of any of examples 1-8, in which computing the query image features includes generating a tensor representation of the query image by performing inference on the query image using a convolutional neural network (CNN), matching the query image features to the candidate tile features includes convolving the tensor representation with at least one candidate tile feature tensor, and determining the pixel coordinates of the aerial vehicle includes selecting pixel coordinates associated with a highest confidence score from the convolved tensor.

Example 10: The method of any of examples 1-9, in which determining the candidate tile features includes selecting candidate tile features based on a previously determined pose of the aerial vehicle.

Example 11: The method of any of examples 1-10, in which the method includes receiving, at the flight control computer, the determined pose, generating, using the flight control computer, a unified pose estimate by combining the determined pose with additional sensor-based poses, evaluating, using the flight control computer, the unified pose against the route parameters, determining, using the flight control computer, a route adjustment based on a deviation from the route parameters, and adjusting, using the flight control computer, at least one flight control parameter, in which the flight control parameter includes at least one of thrust or control surface position.

Example 12: The method of any of examples 1-11, in which the method includes receiving, at the pre-flight planning system, georeferenced map images, segmenting, using the pre-flight planning system, the georeferenced map images into tiles, and generating, using the pre-flight planning system, tile features for each tile.

Example 13: The method of any of examples 1-12, in which segmenting the georeferenced map images into tiles includes segmenting the images based on at least one of a processing capability of the aerial vehicle, a storage constraint of the aerial vehicle, or a route length parameter.

Example 14: The method of any of examples 1-13, in which generating the tile features includes detecting, using the pre-flight planning system, at least one keypoint in each tile, generating, using the pre-flight planning system, a descriptor for each detected keypoint, associating, using the pre-flight planning system, the keypoint and descriptor with tile metadata, and storing the tile metadata as part of the tile features.

Example 15: The method of any of examples 1-14, in which generating the tile features includes generating, using the pre-flight planning system, a tensor representation for each tile by performing inference on the tile using a convolutional neural network (CNN), and associating, using the pre-flight planning system, the tensor representation with the corresponding tile features.

Example 16: The method of any of examples 1-15, in which the method includes receiving, at the pre-flight planning system, mission requirements including an origin and a destination, calculating, using the pre-flight planning system, a route based on the mission requirements, retrieving, using the pre-flight planning system, tile features associated with the route, storing, using the pre-flight planning system, the retrieved tile features as part of the route features, and deploying, from the pre-flight planning system, mission parameters to the aerial vehicle, in which the mission parameters include the route, the route features, and the coordinate mapping function.

As used in this application, terminology such as “component,” “module,” “system,” etc., is intended to encompass a computer-related entity. These entities may involve, among other possibilities, hardware, firmware, a blend of hardware and software, software alone, or software in an operational state. As examples, a component may encompass a running process on a processor, the processor itself, an object, an executable file, a thread of execution, a program, or a computing device. To illustrate further, both an application operating on a computing device and the computing device itself may be designated as a component. A component might be situated within a single process or thread of execution or could be distributed across multiple processors or cores. In addition, these components may operate based on various non-volatile computer-readable media that store diverse instructions and/or data structures. Communication between components may take place through local or remote processes, function, or procedure calls, electronic signaling, data packet exchanges, memory interactions, among other known methods of network, computer, processor, or process-related communications.

A variety of memory types and technologies, both currently available and anticipated for future development, may be incorporated into systems and computing devices that implement the various embodiments. These memory technologies may include non-volatile random-access memories (NVRAM) such as magnetoresistive RAM (MRAM), resistive random-access memory (ReRAM or RRAM), phase-change memory (PCM, PC-RAM, or PRAM), ferroelectric RAM (FRAM), spin-transfer torque magnetoresistive RAM (STT-MRAM), and three-dimensional cross point (3D XPoint) memory. Non-volatile or read-only memory (ROM) technologies may also be included, such as programmable read-only memory (PROM), field programmable read-only memory (FPROM), and one-time programmable non-volatile memory (OTP NVM). Volatile random-access memory (RAM) technologies may further be utilized, including dynamic random-access memory (DRAM), double data rate synchronous dynamic random-access memory (DDR SDRAM), static random-access memory (SRAM), and pseudostatic random-access memory (PSRAM). Additionally, systems and computing devices implementing these embodiments may use solid-state non-volatile storage mediums, such as FLASH memory. The aforementioned memory technologies may store instructions, programs, control signals, and/or data for use in computing devices, system-on-chip (SoC) components, or other electronic systems. Any references to specific memory types, interfaces, standards, or technologies are provided for illustrative purposes and do not limit the claims to any particular memory system or technology unless explicitly recited in the claim language.

The foregoing method descriptions and the process flow diagrams are provided merely as illustrative examples and are not intended to require or imply that the blocks of the various aspects must be performed in the order presented. As may be appreciated by one of skill in the art the order of steps in the foregoing aspects may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithmic steps described in connection with the aspects disclosed herein may be implemented as electronic hardware, computer software, or combinations of both. To clearly illustrate the interchangeability of hardware and software, various components, blocks, modules, circuits, and steps have been described in terms of their functionality. Whether such functionality is implemented as hardware or software may depend on the specific application and the design constraints of the overall system. Skilled artisans may implement the described functionality in different ways for each particular application, and such implementation decisions should not be interpreted as limiting or altering the scope of the claims unless explicitly recited in the claim language.

The hardware used to implement the various illustrative logics, logical blocks, modules, and circuits described in connection with the embodiments disclosed herein may include or be performed by a general-purpose processor, a digital signal processor (DSP), an application-specific integrated circuit (ASIC), a field-programmable gate array (FPGA), a graphics processing unit (GPU), a tensor processing unit (TPU), or other programmable logic devices, discrete gate or transistor logic, discrete hardware components, or any combination thereof, designed to perform the functions described. A general-purpose processor may be a microprocessor, or alternatively, it may be any conventional processor, controller, microcontroller, or state machine. A processor may also be implemented as a combination of computing devices, such as a DSP combined with a microprocessor, multiple microprocessors, one or more microprocessors used in conjunction with a DSP core, a GPU, or AI accelerators such as TPUs. Alternatively, some operations or methods may be performed by circuitry designed specifically for a given function.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module that resides on a non-transitory computer-readable or processor-readable storage medium. Non-transitory computer-readable or processor-readable storage media include any storage media that may be accessed by a computer or processor. By way of example, but not limitation, such non-transitory computer-readable or processor-readable media may include RAM, ROM, EEPROM, flash memory, SSDs, NVMe drives, 3D NAND flash, or any other medium capable of storing program code in the form of instructions or data structures that may be accessed by a computer. Cloud-based storage solutions, including infrastructure-as-a-service (IaaS) platforms, may provide scalable and distributed options for storing and accessing program code. In addition, the operations of a method or algorithm may reside as one or more sets of instructions or code on a non-transitory processor-readable or computer-readable medium, which may be incorporated into a computer program product. Emerging technologies, such as quantum computing storage media and blockchain-based storage solutions, may enhance data integrity and security. AI and ML-improved hardware accelerators, such as GPUs, TPUs, and other dedicated processing units, may be used to efficiently execute complex algorithms.

The preceding description of the disclosed aspects is provided to enable any person skilled in the art to make or use the present invention. Various modifications to these aspects will be readily apparent to those skilled in the art, and the generic principles defined herein may be applied to other aspects without departing from the scope of the invention. Thus, the present invention is not intended to be limited to the aspects shown herein but is to be accorded the widest scope consistent with the following claims and the principles and novel features disclosed herein.

What is claimed is:

1. An aerial vehicle, comprising:
an flight control computer;
an on-board image sensor; and
a processing system coupled to the flight control computer and the on-board image sensor, wherein the processing system is configured to:
receive mission parameters from a pre-flight planning system, the mission parameters including a route, route features, and a coordinate mapping function, wherein the route features include at least one tile feature;
capture, using the on-board image sensor, a query image of an area corresponding to the route;
compute query image features from the query image;
determine candidate tile features from the route features based on the mission parameters;
match the query image features to the candidate tile features to identify a matching tile;
determine pixel coordinates of the aerial vehicle within the matching tile;
determine a pose of the aerial vehicle using the pixel coordinates and the coordinate mapping function; and
send the determined pose to the flight control computer.

2. The aerial vehicle of claim 1, wherein the processing system is configured to:
receive the mission parameters by receiving a threshold score associated with pixel coordinate accuracy; and
determine the pixel coordinates of the aerial vehicle by:
calculating a confidence score for the pixel coordinates; and
discarding the pixel coordinates in response to determining that the confidence score is below the threshold score.

3. The aerial vehicle of claim 1, wherein the processing system is configured to capture, using the on-board image sensor, the query image of the area corresponding to the route by adjusting the exposure of the query image based on ambient lighting conditions.

4. The aerial vehicle of claim 1, wherein the processing system is configured to capture, using the on-board image sensor, the query image of the area corresponding to the route by adjusting the query image based on orientation data obtained from an inertial measurement unit (IMU) of the aerial vehicle.

5. The aerial vehicle of claim 1,
wherein the processing system is configured to compute the query image features by:
detecting at least one keypoint in the query image; and
generating a descriptor for each detected keypoint;
wherein the processing system is configured to match the query image features to the candidate tile features by:
selecting at least one candidate tile keypoint corresponding to a detected query image keypoint;
determining a candidate tile score by computing a distance metric between a descriptor of the query image keypoint and a descriptor of the candidate tile keypoint; and
selecting a best candidate tile based on the candidate tile score; and
wherein determining the pixel coordinates of the aerial vehicle comprises:
generating a homography matrix based on the best candidate tile; and
applying the homography matrix to the pixel coordinates of a central region of the query image.

6. The aerial vehicle of claim 5, wherein the processing system is configured to generate the descriptor for each detected keypoint by generating a feature vector representing spatial relationships of pixel coordinates relative to the keypoint.

7. The aerial vehicle of claim 1, wherein the processing system is configured to:
compute the query image features from the query image by generating a tensor representation of the query image by performing inference on the query image using a convolutional neural network (CNN);
match the query image features to the candidate tile features by convolving the tensor representation with at least one candidate tile feature tensor; and
determine the pixel coordinates of the aerial vehicle by selecting pixel coordinates associated with a highest confidence score from the convolved tensor.

8. The aerial vehicle of claim 1, wherein the processing system is configured to determine the candidate tile features by selecting candidate tile features based on a previously determined pose of the aerial vehicle.

9. The aerial vehicle of claim 1, wherein the flight control computer is configured to:
receive the determined pose;
generate a unified pose estimate by combining the determined pose with additional sensor-based poses;
evaluate the unified pose against the route parameters;
determine a route adjustment based on a deviation from the route parameters; and
adjust at least one flight control parameter, wherein the flight control parameter includes at least one of thrust or control surface position.

10. The aerial vehicle of claim 1, wherein the processing system is configured to cause the pre-flight planning system to:
receive georeferenced map images;
segment the georeferenced map images into tiles; and
generate tile features for each tile.

11. The aerial vehicle of claim 10, wherein the processing system is configured to cause the pre-flight planning system to segment the georeferenced map images into tiles by segmenting the images based on at least one of:
a processing capability of the aerial vehicle;
a storage constraint of the aerial vehicle; or
a route length parameter.

12. The aerial vehicle of claim 10, wherein the processing system is configured to cause the pre-flight planning system to generate the tile features by:
detecting at least one keypoint in each tile;
generating a descriptor for each detected keypoint;
associating the keypoint and descriptor with tile metadata; and
storing the tile metadata as part of the tile features.

13. The aerial vehicle of claim 10, wherein the processing system is configured to cause the pre-flight planning system to generate the tile features by:
generating a tensor representation for each tile by performing inference on the tile using a convolutional neural network (CNN); and
associating the tensor representation with the corresponding tile features.

14. The aerial vehicle of claim 1, wherein the processing system is configured to cause the pre-flight planning system to:
receive mission requirements comprising an origin and a destination;
calculate a route based on the mission requirements;
retrieve tile features associated with the route;
store the retrieved tile features as part of the route features; and
deploy mission parameters to the aerial vehicle, wherein the mission parameters include the route, the route features, and the coordinate mapping function.

15. A method of determining the pose of an aerial vehicle using route features, the method comprising:
receiving, at a processing system of the aerial vehicle, mission parameters from a pre-flight planning system, the mission parameters including a route, route features, and a coordinate mapping function, wherein the route features include at least one tile feature;
capturing, using an on-board image sensor of the aerial vehicle, a query image of an area corresponding to the route;
computing, by the processing system, query image features from the query image;
determining, by the processing system, candidate tile features from the route features based on the mission parameters;
matching, by the processing system, the query image features to the candidate tile features to identify a matching tile;
determining, by the processing system, pixel coordinates of the aerial vehicle within the matching tile;
determining, by the processing system, a pose of the aerial vehicle using the pixel coordinates and the coordinate mapping function; and
sending the determined pose to a flight control computer of the aerial vehicle.

16. The method of claim 15, wherein:
receiving the mission parameters comprises receiving a threshold score associated with pixel coordinate accuracy; and
determining the pixel coordinates of the aerial vehicle comprises:
calculating a confidence score for the pixel coordinates; and
discarding the pixel coordinates in response to determining that the confidence score is below the threshold score.

17. The method of claim 15, wherein capturing the query image comprises adjusting the exposure of the query image based on ambient lighting conditions.

18. The method of claim 15, wherein capturing the query image comprises adjusting the query image based on orientation data obtained from an inertial measurement unit (IMU) of the aerial vehicle.

19. The method of claim 15,
wherein computing the query image features comprises:
detecting at least one keypoint in the query image; and
generating a descriptor for each detected keypoint;
wherein matching the query image features to the candidate tile features comprises:
selecting at least one candidate tile keypoint corresponding to a detected query image keypoint;
determining a candidate tile score by computing a distance metric between a descriptor of the query image keypoint and a descriptor of the candidate tile keypoint; and
selecting a best candidate tile based on the candidate tile score; and
wherein determining the pixel coordinates of the aerial vehicle comprises:
generating a homography matrix based on the best candidate tile; and
applying the homography matrix to the pixel coordinates of a central region of the query image.

20. The method of claim 19, wherein generating the descriptor for each detected keypoint comprises generating a feature vector representing spatial relationships of pixel coordinates relative to the keypoint.

21. The method of claim 15, wherein:
computing the query image features comprises generating a tensor representation of the query image by performing inference on the query image using a convolutional neural network (CNN);
matching the query image features to the candidate tile features comprises convolving the tensor representation with at least one candidate tile feature tensor; and
determining the pixel coordinates of the aerial vehicle comprises selecting pixel coordinates associated with a highest confidence score from the convolved tensor.

22. The method of claim 15, wherein determining the candidate tile features comprises selecting candidate tile features based on a previously determined pose of the aerial vehicle.

23. The method of claim 15, further comprising:
receiving, at the flight control computer, the determined pose;
generating, using the flight control computer, a unified pose estimate by combining the determined pose with additional sensor-based poses;
evaluating, using the flight control computer, the unified pose against the route parameters;
determining, using the flight control computer, a route adjustment based on a deviation from the route parameters; and
adjusting, using the flight control computer, at least one flight control parameter, wherein the flight control parameter includes at least one of thrust or control surface position.

24. The method of claim 15, further comprising:
receiving, at the pre-flight planning system, georeferenced map images;
segmenting, using the pre-flight planning system, the georeferenced map images into tiles; and
generating, using the pre-flight planning system, tile features for each tile.

25. The method of claim 24, wherein segmenting the georeferenced map images into tiles comprises segmenting the images based on at least one of:
a processing capability of the aerial vehicle;
a storage constraint of the aerial vehicle; or
a route length parameter.

26. The method of claim 24, wherein generating the tile features comprises:
detecting, using the pre-flight planning system, at least one keypoint in each tile;
generating, using the pre-flight planning system, a descriptor for each detected keypoint;
associating, using the pre-flight planning system, the keypoint and descriptor with tile metadata; and
storing the tile metadata as part of the tile features.

27. The method of claim 24, wherein generating the tile features comprises:
generating, using the pre-flight planning system, a tensor representation for each tile by performing inference on the tile using a convolutional neural network (CNN); and
associating, using the pre-flight planning system, the tensor representation with the corresponding tile features.

28. The method of claim 15, further comprising:
receiving, at the pre-flight planning system, mission requirements comprising an origin and a destination;
calculating, using the pre-flight planning system, a route based on the mission requirements;
retrieving, using the pre-flight planning system, tile features associated with the route;
storing, using the pre-flight planning system, the retrieved tile features as part of the route features; and
deploying, from the pre-flight planning system, mission parameters to the aerial vehicle, wherein the mission parameters include the route, the route features, and the coordinate mapping function.

29. A non-transitory processor-readable storage medium having stored thereon processor-executable instructions configured to cause a processing system in a computing device to perform operations for determining the pose of an aerial vehicle using route features, the operations comprising:
receiving mission parameters from a pre-flight planning system, the mission parameters including a route, route features, and a coordinate mapping function, wherein the route features include at least one tile feature;
capturing a query image of an area corresponding to the route;
computing query image features from the query image;
determining candidate tile features from the route features based on the mission parameters;
matching the query image features to the candidate tile features to identify a matching tile;
determining pixel coordinates of the aerial vehicle within the matching tile;
determining a pose of the aerial vehicle using the pixel coordinates and the coordinate mapping function; and
sending the determined pose to a flight control computer of the aerial vehicle.

30. A flight control computer, comprising:
a processing system configured to:
receive a determined pose of an aerial vehicle;
generate a unified pose estimate by combining the determined pose with additional sensor-based poses;
evaluate the unified pose against route parameters;
determine a route adjustment based on a deviation from the route parameters; and
adjust at least one flight control parameter, wherein the flight control parameter includes at least one of thrust or control surface position.

31. A pre-flight planning computing system, comprising:
a processing system configured to:
receive georeferenced map images;
segment the georeferenced map images into tiles based on at least one of:
a processing capability of an aerial vehicle;
a storage constraint of the aerial vehicle; or
a route length parameter; and
generate tile features for each tile.

32. A pre-flight planning computing system, comprising:
a processing system configured to:
receive mission requirements comprising an origin and a destination;
calculate a route based on the mission requirements;
retrieve tile features associated with the route;
store the retrieved tile features as part of route features; and
deploy mission parameters to an aerial vehicle, wherein the mission parameters include the route, the route features, and a coordinate mapping function.
